(19) United States
(12) Patent Application Publication
(10) Pub. No.: US 2025/0070852 A1
(43) Pub. Date: Feb. 27, 2025

(54) SYSTEMS, APPARATUS, ARTICLES OF MANUFACTURE, AND METHODS FOR CONFIGURING BASE STATIONS USING BEAM MANAGEMENT

(71) Applicants: Henry Ye, Andover, MA (US); Sujie Chen, Fanling (HK); Hongwei Kong, Basking Ridge, NJ (US)

(72) Inventors: Henry Ye, Andover, MA (US); Sujie Chen, Fanling (HK); Hongwei Kong, Basking Ridge, NJ (US)

(21) Appl. No.: 18/763,335

(22) Filed: Jul. 3, 2024

Related U.S. Application Data
(60) Provisional application No. 63/512,484, filed on Jul. 7, 2023.

(51) Int. Cl. H04B 7/08; H04B 7/06

(52) U.S. Cl. CPC H04B 7/088; H04B 7/0626

(57) ABSTRACT

The techniques described herein relate to systems, apparatus, articles of manufacture, and methods for configuring base stations using beam management. An example method includes determining a first measurement based on a first reference signal of a plurality of reference signals from a plurality of base stations and received at a cellular device, the first reference signal received at the cellular device from a first base station of the plurality of base stations using a beam associated with a beam index, the beam index corresponding to the first base station. The example method further includes determining whether the first measurement satisfies a threshold, selecting the beam for communication between the cellular device and the first base station after determining that the first measurement satisfies the threshold, and configuring the cellular device using the beam index to facilitate communication between the cellular device and the first base station.

### CROSS-REFERENCE TO RELATED APPLICATIONS

This application is a non-provisional that claims the benefit under 35 U.S.C. § 119(e) of U.S. Provisional Application Ser. No. 63/512,484, filed on Jul. 7, 2023, entitled “SYSTEMS, APPARATUS, ARTICLES OF MANUFACTURE, AND METHODS FOR CONFIGURING BASE STATIONS USING BEAM MANAGEMENT,” which is incorporated herein by reference in its entirety.

### FIELD

The techniques described herein relate generally to wireless networks and, more particularly, to systems, apparatus, articles of manufacture, and methods for configuring base stations using beam management.

### BACKGROUND

Multiple generations of standards are used in the telecommunications (“telecom”) industry. Some exemplary standards are set forth by the Open Radio Access Network (O-RAN) Alliance, such as the O-RAN Architecture Description (e.g., O-RAN Alliance specification O-RAN.WG1.O-RAN-Architecture-Description-v07.00 or later), which specify exemplary telecom architectures and related functions and interfaces to implement mobile networks. A mobile network, such as a mobile network based on the O-RAN Architecture, may split the baseband functionality at the boundary of the media access control (MAC) and physical (PHY) layers, leaving all PHY functions in the radio unit. Such a split may provide sufficient cellular coverage for relatively small areas, venues, etc. However, such a split may provide insufficient cellular coverage for relatively medium to large areas, venues, etc.

### SUMMARY OF THE DISCLOSURE

In accordance with the disclosed subject matter, apparatus, systems, and methods are provided for configuring base stations using beam management.

Some embodiments relate to an exemplary method for base station management. The exemplary method comprises determining a first measurement based on a first reference signal of a plurality of reference signals from a plurality of base stations and received at a cellular device, the first reference signal received at the cellular device from a first base station of the plurality of base stations using a beam associated with a beam index, the beam index corresponding to the first base station; determining whether the first measurement satisfies a threshold; selecting the beam for communication between the cellular device and the first base station after determining that the first measurement satisfies the threshold; and configuring the cellular device using the beam index to facilitate communication between the cellular device and the first base station.

Some embodiments relate to another exemplary method for base station management. The exemplary method comprises receiving a beam index from a cellular device indicating that a beam corresponding to the beam index is associated with a measurement satisfying a threshold; configuring a base station corresponding to the beam index to communicate with the cellular device; and transmitting data to the cellular device to cause configuration of the cellular device such that communication between the cellular device and the base station is through the beam.

Some embodiments relate to an apparatus comprising at least one memory storing instructions, and at least one processor configured to execute the instructions to perform any one(s) of the aforementioned methods.

Some embodiments relate to at least one non-transitory computer-readable storage medium comprising instructions that, when executed, cause at least one processor to perform any one(s) of the aforementioned methods.

Some embodiments relate to a system comprising at least one memory storing instructions, and at least one processor configured to execute the instructions to perform any one(s) of the aforementioned methods.

The foregoing summary is not intended to be limiting. Moreover, various aspects of the present disclosure may be implemented alone or in combination with other aspects.

### BRIEF DESCRIPTION OF FIGURES

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 is an illustration of an exemplary cellular network that includes a plurality of radio units to implement a supercell, according to some embodiments.

FIG. 2 is an illustration of a functional split of baseband functionality that may implement a portion of the exemplary cellular network of FIG. 1, according to some embodiments.

FIG. 3 depicts an example implementation of a supercell, according to some embodiments.

FIG. 4 depicts another example implementation of a supercell, according to some embodiments.

FIG. 5 is an illustration of a base station performing beam sweeping to facilitate communication with a cellular device, according to some embodiments.

FIG. 6 is an illustration of configuring a base station in a supercell using beam management, according to some embodiments.

FIG. 7 is an illustration of a conventional base station handover technique.

FIG. 8 is a block diagram of an exemplary implementation of a cellular device, according to some embodiments.

FIG. 9 is a block diagram of an exemplary implementation of a distributed unit, according to some embodiments.

FIG. 10 is a flowchart representative of example machine-readable instructions that may be executed by processor circuitry to implement the cellular device of FIG. 8 to configure a cellular device using beam management, according to some embodiments.

FIG. 11 is a flowchart representative of example machine-readable instructions that may be executed by processor circuitry to implement the cellular device of FIG. 8 and/or the distributed unit of FIG. 9 to configure base station(s) to communicate with a cellular device in a supercell, according to some embodiments.

FIG. 12 is a flowchart representative of example machine-readable instructions that may be executed by processor circuitry to implement the distributed unit of FIG. 9 to coordinate base stations corresponding to beams that satisfy a threshold to communicate with a cellular device, according to some embodiments.

FIG. 13 is a flowchart representative of example machine-readable instructions that may be executed by processor circuitry to implement the cellular device of FIG. 8 to facilitate communication of the cellular device using one or more beams, according to some embodiments.

FIG. 14 is a flowchart representative of example machine-readable instructions that may be executed by processor circuitry to implement the distributed unit of FIG. 9 to facilitate communication of a base station with a cellular device, according to some embodiments.

FIG. 15 is an example electronic platform structured to execute the machine-readable instructions of FIGS. 10, 11, and/or 13 to implement the cellular device of FIG. 8, according to some embodiments.

FIG. 16 is an example electronic platform structured to execute the machine-readable instructions of FIGS. 11, 12, and/or 14 to implement the distributed unit of FIG. 9, according to some embodiments.

### DETAILED DESCRIPTION

The present application generally provides techniques for configuring base stations using beam management. Base stations may exchange wireless data with electronic devices. Wireless data may be implemented as cellular data generated, received, and/or transmitted in accordance with various cellular standards and/or architectures, such as third generation cellular (e.g., 3G), fourth generation long-term evolution cellular (e.g., 4G LTE), fifth generation cellular (e.g., 5G), future sixth generation cellular or next generation cellular, etc., standards and/or architectures. For example, wireless data may be transmitted and/or received by an electronic device associated with an end user (e.g., user equipment (UE)) in a telecommunications network (e.g., sometimes “telecom network” or “Telcom network”).

In some examples, the telecom network may be implemented by an architecture based on a standard associated with the 3rd Generation Partnership Project (“3GPP”), the Open Radio Access Network (O-RAN) Alliance (“O-RAN Alliance”), or the like. For example, the telecom network may be a mobile communication network based on an architecture as set forth in the O-RAN Architecture Description (e.g., O-RAN Alliance Specification O-RAN.WG1.O-RAN-Architecture-Description-v07.00 or later).

A mobile network, such as a mobile network based on the O-RAN architecture, may include several network portions to facilitate data transfer within the mobile network. For example, the mobile network may include a front-haul portion, a mid-haul portion, and a back-haul portion. In some examples, first components, functions, etc., of the front-haul portion are communicatively and/or physically coupled to second components, functions, etc., of the mid-haul portion. In some examples, the second components/functions, etc., of the mid-haul portion may be communicatively and/or physically coupled to third components, functions, etc., of the back-haul portion, and so on.

In some examples, the front-haul portion may be implemented by a front-haul interface, which facilitates communication between a transceiver, such as a radio unit (RU) (also referred to as an “O-RU” when utilized in O-RAN mobile networks), and a baseband signal processor, such as a baseband unit (BBU) of a base station. For example, in a 4G LTE O-RAN mobile network, the RU and the BBU may implement an eNodeB (CNB), which refers to a node that provides connectivity between UE and the 4G Core (also referred to as the “evolved packet core (EPC),” the “core network,” or the “4G core network”). In some examples, the BBU may be functionally split into a distributed unit (DU) (also referred to as an O-DU when utilized in O-RAN mobile networks) and a centralized unit (CU) (also referred to as a “control unit,” “a central unit,” or an “O-CU” when utilized in O-RAN mobile networks). For example, in a 5G O-RAN mobile network, the O-DU and the O-CU may implement a gNodeB (gNB), which refers to a node that provides connectivity between UE and the 5G Core (also referred to as the “core network” or the “5G core network”).

In some examples, the mid-haul portion may be implemented by a mid-haul interface, which facilitates communication between the functions of the base station. For example, the mid-haul interface may be implemented by the communication interface between the DU and the CU. In some examples, the back-haul portion may be implemented by a back-haul interface, which facilitates communication between the CU and the 5G Core. In some instances, the 5G core may be in communication with a central facility associated with one or more servers to process a request associated with the wireless data from the UE, push information to the UE via the back-haul through front-haul interfaces, etc. Alternatively in other types of mobile networks, such as a 4G LTE network, the back-haul portion may be implemented by a back-haul interface that facilitates communication between the BBU and the 4G Core.

In some examples, the RU, DU, and/or CU may split the hosting of different gNB functions (or eNB functions with respect to 4G LTE implementations) based on the deployed architecture. By way of example, an O-RAN mobile network architecture may functionally and/or physically split the lower layer of the front-haul interface based on Split Architecture Option 6 as specified by O-RAN Hardware Reference Design Specification for Indoor Pico Cell with Fronthaul Split Option 6 2.0 (e.g., O-RAN Alliance Specification O-RAN.WG7.IPC-HRD-Opt6-v02.00 or later). For example, an O-DU configured to use Split Option 6 may perform media access control (MAC) functions while physical (PHY) functions are performed in the O-RU. In Split Option 6 architectures, the O-DU and the O-RU may be connected via a functional application platform interface (nFAPI) over fiber and/or ethernet transport. In Split Option 6 architectures, the O-RU may include complete physical layer processing functions and the O-DU may handle higher layer processing functions. For example, the O-RU may include and/or implement high-PHY and low-PHY functions while the O-DU includes and/or implements a digital processing unit to perform higher layer processing functions such as MAC and/or radio link control (RLC).

By way of another example, an O-RAN mobile network architecture may functionally and/or physically split the lower layer of the front-haul interface based on Split Architecture Option 7-2x as specified by O-RAN Control, User and Synchronization Plane Specification 10.0 (e.g., O-RAN Alliance Specification O-RAN.WG4.CUS.0-v10.00 or later). For example, the O-RU may host low PHY layer and radio-frequency (RF) processing and the O-DU may host high-PHY, MAC, and RLC processing based on the lower layer functional split. The O-RU implementation in Split Option 6 and/or Split Option 7-2x may be less complex by having the O-RU host fewer functions by shifting functions from the O-RU to the O-DU. As a result, the O-RU may have reduced memory requirements and may execute fewer real-time calculations and thereby enable reduced latency in the mobile network.

Different portions of mobile networks may be located and/or used in a variety of environments, such as indoor and outdoor deployments. In indoor/outdoor environments, physical separation of RUs and BBUs, such as DUs, are typical due to the flexibility in implementing coverage extension. For example, RUs can be installed in rural areas and/or challenging environments where user density is low, on an as-needed basis, without the need to change the location of the DUs, and/or without the need to upgrade the capacity, utilization, and/or capabilities of the DUs. In some instances, RUs can be installed in high-density user scenarios (e.g., apartment buildings, shopping malls, sports stadiums, etc.). In some such instances, multiple RUs belonging to the same cell (e.g., the same network cell) may be deployed to minimize and/or otherwise reduce intercell interference and frequent UE handovers.

The inventors have recognized that deploying a cell to achieve optimal and/or otherwise improved coverage for an area, a venue, and/or a zone is challenging due to a variety of factors, such as limitations on total throughput and/or number of users. The inventors have recognized that relatively small cells may provide sufficient coverage for small venues. The inventors have recognized that some conventional approaches use a number of different small cells that are physically spread out from each other. However, such conventional approaches may not provide sufficient coverage for medium to large venues due, for example, at least in part to inter-cell interferences among the small cells.

An exemplary approach to reducing inter-cell interferences is to group multiple small cells to form a single supercell. In some instances, a supercell is a large-area coverage solution that may leverage a plurality of cells, which may be implemented by base stations and/or gNBs, respectively including high-gain, narrow-sectored antennas to increase cellular data coverage range and capacity. In some supercells, all of the small cells in the supercells send out the same signals to a UE and the UE correspondingly communicates with each of the small cells. In some supercells, there is no handover required when a UE moves and crosses a small cell boundary (e.g., moving from within a first boundary of a first cell to within a second boundary of a second cell). Beneficially, UEs at the small cell boundaries can benefit from the receptions of signal transmitted from multiple small cells. However, the inventors have recognized that peak throughput and user capacity does not grow with the number of small cells in the same supercell. For example, the peak rate in the supercell may correspond and/or equal to (or be limited to) the peak rate in a single small cell. In another example, the number of supported users in the supercell may correspond to and/or equal to (or be limited to) the number of supported users in a single small cell.

Another approach to reducing inter-cell interferences is to enhance the functionality of inter-cell coordination such that small cells monitor (e.g., actively monitor) UE locations. By monitoring UE locations, communications between small cells and UEs may be coordinated based on UE specific locations. However, the inventors have recognized that such location-based inter-cell coordination does not eliminate handovers when UEs cross cell boundaries, which causes service gaps (e.g., in the order of a few seconds). In addition, the small cells may not be able to accurately track the UE locations due to its complexity and therefore cannot optimally mitigate the interferences.

The inventors have recognized that the aforementioned approaches do not sufficiently eliminate and/or otherwise reduce inter-cell interference and/or base station handovers in a manner that can scale the data rate and/or number of supported users. The inventors have developed technology as disclosed herein that can be used to configure and/or manage a supercell, which may be established by combining a plurality of small (or smaller) cells, using beam management.

Beam management is a set of Layer 1 (PHY) and Layer 2 (MAC) procedures to establish and retain an optimal beam pair for sufficient connectivity. A beam pair consists of a transmit beam and a corresponding receive beam in one link direction. Before a UE can communicate with a cellular network, the UE performs cell search and selection procedures and obtains initial cell synchronization and system information. The process may include acquiring frame synchronization, identifying the cell identity, and decoding the master information block (MIB) and the system information block (SIB1). In a multi-antenna system implementation that transmits multiple beams, a UE may attempt to detect all of the beams in the search space and thereby attempt to detect all of the beams from a particular base station.

In some disclosed embodiments, a base station may perform beam sweeping by sequentially sending reference signals in different directions. For example, the base station may broadcast and/or transmit directional signals for each beam. A UE may receive and process the reference signals from one or more of the beam(s). Based on the processed reference signals, the UE may identify one or more beam indices that correspond to the best received beam(s). The UE may report the one or more detected beam indices to the base station. The base station may use one or more beam(s) reported by UE to communicate with the UE on both downlink (DL) and uplink (UL).

In some disclosed embodiments, the UE may periodically or aperiodically detect other beams and/or search for other beams different from the beam(s) currently utilized by the UE to communicate with the base station. The UE may determine that another detected beam is stronger than the currently connected beam such that the other detected beam has a greater beam strength than the currently connected beam. The UE may inform, notify, and/or report the new beam index corresponding to the detected beam to the base station. The base station may configure the UE to switch to the new beam for further communication. Beneficially, in some embodiments, the base station may use MAC control command(s), such as MAC Control Element, or RRC control command, such as RRC Reconfiguration Message, to notify the UE for fast beam switch.

In some embodiments, a plurality of exemplary base stations can be grouped to form a supercell with a common DU. The DU may be placed in a centralized location and connected to the base stations through interfaces such as but not limited to various split options defined by 3GPP and/or O-RAN (e.g., Option 6, Option 7, or Option 8). In such various split options, the base stations may be gNBs that operate as RUs. The signals sent out from the different base stations may constitute different beams of the same supercell. UEs in an exemplary supercell may analyze, evaluate, and/or treat signals from different base stations as different beams from a single cell (e.g., the supercell). For example, a DU may configure different base stations to transmit different beams to the UE. The UE may perform a beam selection process to evaluate the different beams such that the UE may be unaware whether the different beams originate from one base station or a plurality of base stations. Beneficially, in some embodiments, the UE may be concerned regarding the beams themselves rather than the originators (e.g., base stations, base stations operating as gNBs, base stations operating as RUs) of the beams. In some embodiments, the UE may select the base station that corresponds to the best beam, such as the beam with the greatest beam strength, detected by the UE for communication. In some embodiments, the UE may identify multiple base stations that correspond to the best beams.

In some embodiments, based on the UE's beam selection, one or more base stations can be configured to communicate with the UE. For example, if the UE selects multiple beams as sufficient that are each associated with a corresponding different base station, the multiple base stations may be configured to transmit the same signal (e.g., duplicate signals) to the UE such that the signals are added up constructively at the UE. Beneficially, the UE can benefit from the receptions of the duplicate signals such that the likelihood of receiving the correct signals increases. Alternatively, if the UE only selects the beam of a closer base station but not the beam of a base station that is further away, then the closer base station to the UE may be configured to transmit the signal to the UE while the other base station does not transmit anything in the overlapping resources. For example, the signal power of the received beam from the closer base station may be greater than the signal power of the received beam from the further base station and thereby the greater signal power may be determinative for selecting the beam from the closer base station. In some embodiments, the UE may transmit wireless data to the multiple base stations such that the multiple base stations may respectively decode the wireless data independently.

The techniques described herein can provide one or more exemplary benefits. For example, in some embodiments, peak rates and user counts may grow by N where N is the number of base stations in the exemplary supercell. As another example, base stations may not need to track UE locations using UL reference signals, such as sounding reference signals (SRS), because the exemplary supercell may rely on the UE's exemplary capability to measure multiple beams, each from one base station. In some embodiments, the exemplary supercell may not perform handovers between base stations because fast beam switch may instead be utilized. In some embodiments, the techniques described herein can be implemented using existing hardware of the base stations, such that the base station hardware need not be changed and therefore currently deployed base stations can be used to implement the techniques described herein. In some embodiments, the techniques described herein can be used in conjunction with existing UE functionality, such that UE functionality need not be modified in order to implement the techniques described herein (e.g., a UE simply performs its pre-programmed beam selection process). The techniques described herein can leverage conventional approaches (e.g., beams) in a new way (e.g., with each base station associated with a different beam, whereas traditionally the beam selection process is used with a single base station that transmits all of the beams) to achieve the techniques as described herein.

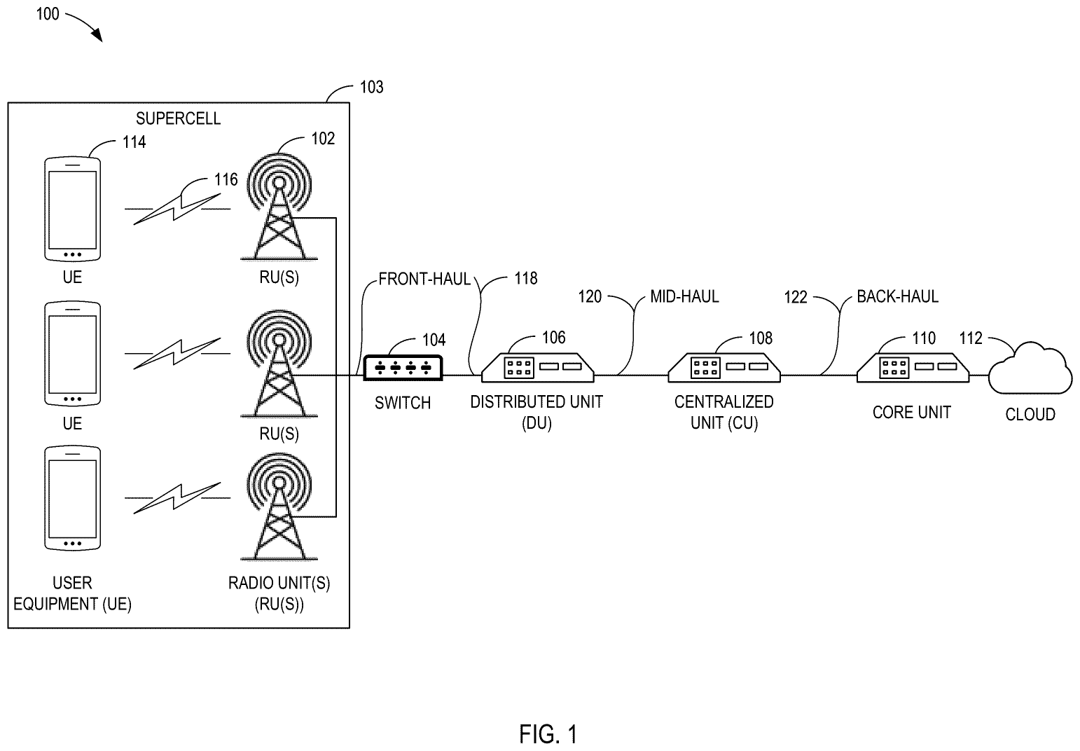

Turning to the figures, the illustrated example of FIG. 1 is an illustration of an exemplary cellular network 100 that includes a plurality of radio units (RUs) 102 to implement a supercell 103. The cellular network 100 further includes a switch 104, a distributed unit (DU) 106, a centralized unit (CU) 108, a core unit 110, and a cloud 112. The cellular network 100 of FIG. 1 is a 5G network system based on an Open Radio Access Network (O-RAN) architecture. Although illustrated with reference to 5G network systems, it should be appreciated that other network configurations and/or architectures are also possible. For example, the techniques described herein could also be applied to other network systems such as 4G LTE network systems or future sixth generation (6G) network systems, as the techniques described herein are not limited in this respect. Although illustrated with reference to O-RAN architectures, other network architectures are also possible. For example, techniques described herein could also be applied to other architectures such as a 3rd Generation Partnership Project (3GPP) or a Small Cell Forum (SCF) architecture. For example, the cellular network 100 may be a 3GPP or SCF cellular network.

In the illustrated example, each of the depicted RU(s) 102 may be one or more RUs. The RUs 102 are logical nodes that may host low physical (PHY) layer, high PHY, and/or radio-frequency (RF) processing based on a lower layer functional split, such as Split Architecture Option 6 as specified by O-RAN Hardware Reference Design Specification for Indoor Pico Cell with Fronthaul Split Option 6 2.0 (e.g., O-RAN Alliance Specification O-RAN.WG7.IPC-HRD-Opt6-v02.00 or later). The RUs 102 may be implemented by hardware alone, or by a combination of hardware, software, and/or firmware. For example, the RUs 102 may be implemented by transceivers that transmit or receive radio waves, and/or associated software and/or firmware.

The RUs 102 are in communication with user equipment (UE) 114 via communication links 116. In this example, the UE 114 are handheld devices, such as Internet-enabled smartphones. For example, the UE 114 are cellular devices, such as electronic devices configured to effectuate the communication of wireless data (e.g., cellular data). Additionally or alternatively, the UE 114 may be any type of electronic device such as a laptop computer, a tablet computer, a television (e.g., a smart television), a set-top box, a streaming device, a wearable device (e.g., headphones, headsets, smartwatches, smart glasses, etc.), autonomous equipment (e.g., an autonomous vehicle, a drone, etc.), an Internet-of-Things (IoT) device, etc.

The communication links 116 are wireless connections. For example, the wireless connections may be 4G LTE wireless connections, 5G wireless connections, future generation (e.g., 6G) wireless connections, and/or the like. In some examples, the wireless connections may be implemented by a 3GPP 5G protocol, a future generation 3GPP protocol, etc. In some examples, the wireless connections may be compatible across generations of 3GPP protocols. For example, the RUs 102 may communicate with some of the UE 114 using a 3GPP 4G protocol and with other ones of the UE 114 using a 3GPP 5G protocol.

Additionally or alternatively, the communication links 116 may be wired connections (e.g., fiber-optic connections, Ethernet connections, etc.) or other type of wireless connections such as satellite connections (e.g., beyond-line-of-site (BLOS) satellite connections, line-of-site (LOS) satellite connections, etc.), Ultra Wideband (UWB) connections, etc.

The supercell 103 of the illustrated example can be established by grouping together one(s) of the RU(s) 102 such that the UE 114 is configured to treat the one(s) of the RU(s) 102 as a single cell. For example, the supercell 103 can be formed by configuring each of the RU(s) 102 with one or more of the same parameters. For example, each of the RU(s) 102 can be configured to have the same cell identifier (ID), scrambling code, and/or the like. For example, the UE 114 can transmit wireless data to each of the RU(s) 102 or a subset thereof. In some embodiments, each of the RU(s) 102 may transmit wireless data to the UE 114. For example, each of the RU(s) 102 may transmit duplicate signals representative of the same wireless data to the UE 114 such that the duplicate signals can be added constructively at the receiving UE 114.

In operation, the RUs 102 may receive wireless data, such as cellular data implemented by RF signals, from the UE 114 via the communication links 116. The RUs 102 may output the received wireless data to the switch 104. Alternatively, the cellular network 100 may include more than one switch 104. In some embodiments, the switch 104 can be a device configured to host, execute, etc., a multiplexing function for splitting and combining radio signals to or from the RUs 102. For example, the switch 104 can implement front-haul multiplexers (FHMs) that are configured to receive radio signals (e.g., baseband signals) from ones of the first RUs 102, combine the radio signals, and output the combined radio signals to the DU 106.

In operation, the RUs 102 may transmit wireless data. For example, the DU 106 may receive network data, the DU 106 may perform baseband processing on the network data to generate baseband processed data, the DU 106 may output the baseband processed data to the switch 104, the switch 104 may split the baseband processed data into different network paths, the switch 104 may output the split network data to ones of the RUs 102 along the different network paths, and the ones of the RUs 102 may transmit their respective network data portions to a node destination, such as one(s) of the UE 114.

The DU 106 of this example is a logical node that may host baseband functions such as radio link control (RLC) and/or media access control (MAC) processing based on a lower layer functional split, such as Split Architecture Option 6 as specified by O-RAN Hardware Reference Design Specification for Indoor Pico Cell with Fronthaul Split Option 6 2.0 (e.g., O-RAN Alliance Specification O-RAN.WG7.IPC-HRD-Opt6-v02.00 or later). The DU 106 may be implemented by hardware alone, or may be implemented by a combination of hardware, software, and/or firmware.

The CU 108 are logical nodes that may host control functions, such as Packet Data Convergence Protocol (PDCP), Radio Resource Control (RRC), and/or Service Data Adaptation Protocol (SDAP). The CU 108 may be implemented by hardware alone, or may be implemented by a combination of hardware, software, and/or firmware.

In this example, the core unit 110 is a logical node that may host data and control plane operations. The core unit 110 of this example is the 5G Core (5GC) and may facilitate communication between the CU 108 and the cloud 112. The cloud 112 may be a cloud network. For example, the cloud 112 may be network(s) hosted by a public cloud provider, a private cloud provider, a telecommunications operator, etc. In some examples, the cloud 112 may be implemented by one or more physical hardware servers, virtualizations of the one or more physical hardware servers, etc., and/or any combination(s) thereof.

The cellular network 100 of the illustrated example includes network portions such as a front-haul portion 118, a mid-haul portion 120, and a back-haul portion 122. The front-haul portion 118 of this example is implemented by the communication interfaces between the RUs 102 and the switch 104 and the communication interfaces between the switch 104 and the DU 106. The mid-haul portion 120 is implemented by the communication interfaces between the DU 106 and the CU 108. The back-haul portion 122 is implemented by the communication interfaces between the CU 108 and the core unit 110.

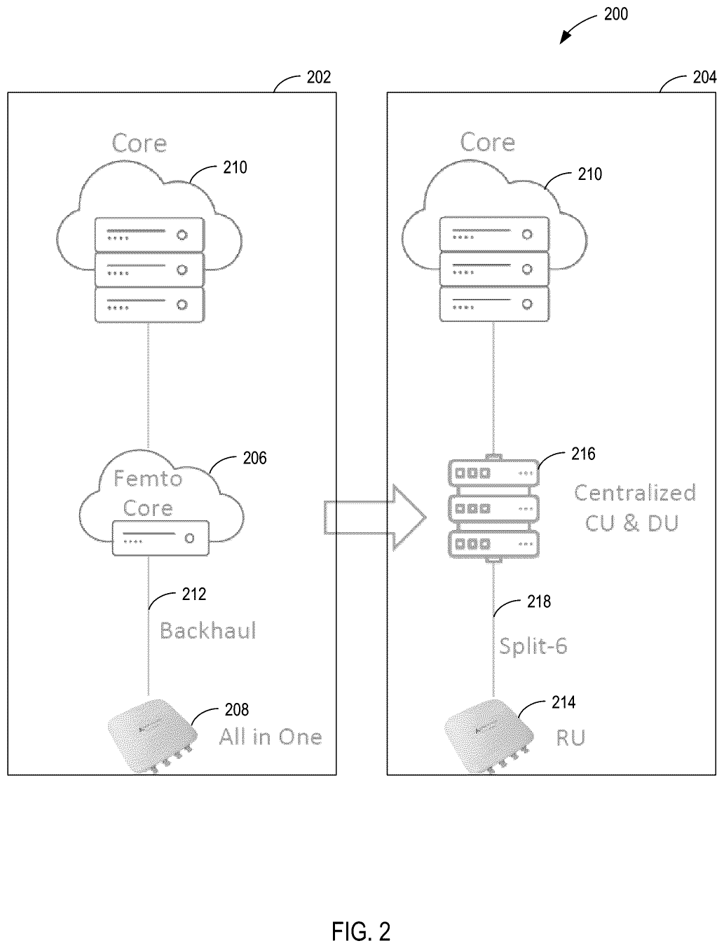

FIG. 2 is an illustration of a functional split 200 of baseband functionality 202, 204 that may implement a portion of the cellular network 100 of FIG. 1. The baseband functionality 202, 204 of this example includes first baseband functionality 202 and second baseband functionality 204. The first baseband functionality 202 is implemented by a Femto core 206, which may implement a Femto cell. In some embodiments, a Femto cell can be a small, low-power cellular base station configured for relatively small coverage areas (e.g., a home residence, a small business, etc.). The Femto core 206 is configured to facilitate communication between an all-in-one base station 208 and a core network 210. For example, the Femto core 206 can be configured to transmit data to and/or receive data from the all-in-one base station 208 via a backhaul 212. The all-in-one base station 208 of this example may implement RU, DU, and/or CU functionality.

The first baseband functionality 202 may be split, segmented, and/or divided as illustrated by the second baseband functionality 204. For example, the all-in-one base station 208 may be split into an RU 214 and a centralized CU and DU 216, which may be connected via a fronthaul 218 in accordance with Split Option 6. In this example, Split Option 6 separates the MAC interface in the centralized CU and DU 216 from the PHY interface in the RU 214. For example, the high-PHY and the low-PHY functions may remain in the RU 214 while MAC and/or other functions may be moved to a centralized location (e.g., a local server room).

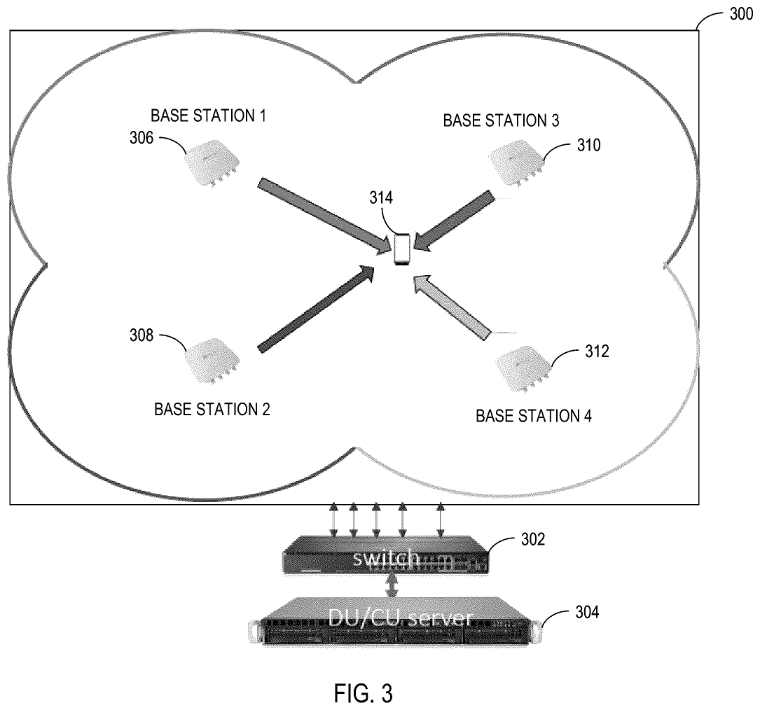

FIG. 3 depicts an example implementation of a supercell 300. The supercell 300 of this example is coupled (e.g., physically coupled, communicatively coupled) to a switch 302, which is in turn coupled to a DU and/or CU server 304. In some embodiments, the supercell 300 can implement the supercell 103 of FIG. 1. In some embodiments, the switch 302 can implement the switch 104 of FIG. 1. In some embodiments, the DU and/or CU server 304 can implement the DU 106 and/or the CU 108 of FIG. 1. For example, the DU/CU server 304 can include and/or implement a DU server, a CU server, and/or a combination thereof. For example, the DU/CU server 304 can include and/or implement the DU 106, the CU 108, and/or a combination thereof.

In some embodiments, the DU/CU server 304 can form the supercell 300 by combining and/or grouping a plurality of base stations 306, 308, 310, 312. The plurality of base stations 306, 308, 310, 312 are respectively identified by base station 1, base station 2, base station 3, and base station 4. One(s) of the base stations 306, 308, 310, 312 is/are in communication with a UE 314. The UE 314 of this example may be a cellular device but may be any other type of electronic device.

In the illustrated example, each of the base stations 306, 308, 310, 312 may transmit wireless data, such as the same wireless data, to the UE 314 such that the duplicative wireless data is added up constructively at the UE 314. Alternatively, one, two, or three of the base stations 306, 308, 310, 312 may be in communication with the UE 314.

In the illustrated example, the UE 314 may transmit wireless data, such as the same wireless data, to each of the base stations 306, 308, 310, 312 because the UE 314 may consider each of the base stations 306, 308, 310, 312 as part of the same cell (e.g., the supercell 300). Alternatively, the UE 314 may be in communication with one, two, or three of the base stations 306, 308, 310, 312.

Beneficially, the DU/CU server 304 may configure the supercell 300 such that no handover is required when the UE 314 moves across small cell boundaries (e.g., moving from a first boundary associated with base station 1 306 to a second boundary associated with base station 2 308). Beneficially, the UE 314 at the small cell boundaries (e.g., at an intersection of two or more boundaries of base station 1 306, base station 2 308, base station 3 310, and/or base station 4 312) may benefit from the receptions of signal transmitted from multiple small cells constructively.

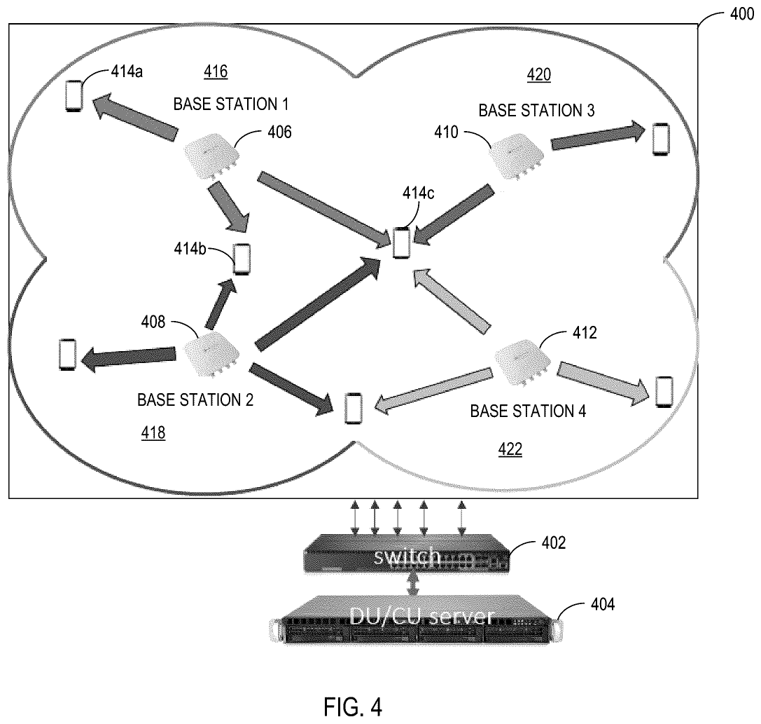

FIG. 4 depicts another example implementation of a supercell 400. The supercell 400 of this example is coupled (e.g., physically coupled, communicatively coupled) to a switch 402, which is in turn coupled to a DU and/or CU server 404. In some embodiments, the supercell 400 can implement the supercell 103 of FIG. 1. In some embodiments, the switch 402 can implement the switch 104 of FIG. 1. In some embodiments, the DU and/or CU server 404 can implement the DU 106 and/or the CU 108 of FIG. 1. For example, the DU/CU server 404 can include and/or implement a DU server, a CU server, and/or a combination thereof. For example, the DU/CU server 404 can include and/or implement the DU 106, the CU 108, and/or a combination thereof.

In some embodiments, the DU/CU server 404 can form the supercell 400 by combining and/or grouping a plurality of base stations 406, 408, 410, 412. The plurality of base stations 406, 408, 410, 412 are respectively identified by base station 1, base station 2, base station 3, and base station 4. In some embodiments, one(s) of the plurality of base stations 406, 408, 410, 412 can implement and/or correspond to one(s) of the RU(s) 102 of FIG. 1. For example, base station 1 406 can implement and/or correspond to a first one of the RU(s) 102, base station 2 408 can implement and/or correspond to a second one of the RU(s) 102, and so on.

One(s) of the base stations 406, 408, 410, 412 is/are in communication with one(s) of a plurality of UEs 414a, 414b, 414c. The UEs 414a, 414b, 414c of this example may be a cellular device but may be any other type of electronic device. For example, one or more of the UEs 414a, 414b, 414c may be smartphones and one or more of the UEs 414a, 414b, 414c may be autonomous equipment.

In the illustrated example, a first UE 414a is within a first boundary (e.g., a first cell boundary) 416 associated with base station 1 406. In some embodiments, the DU/CU server 404 can configure the first UE 414a and base station 1 406 to be in communication with each other.

In the illustrated example, a second UE 414b is within the first boundary 416 and a second boundary 418 associated with base station 2 408 such that the second UE 414b is in an overlapping boundary. For example, the second UE 414b may be positioned such that the second UE 414b is within the first boundary 416 and the second boundary 418. In some embodiments, the DU/CU server 404 can configure base station 1 406 and base station 2 408 to both be in communication with the second UE 414b. For example, the DU/CU server 404 can configure base station 1 406 and base station 2 408 to transmit the same wireless data, such as duplicate signals, to the second UE 414b. In some embodiments, the DU/CU server 404 can configure base station 1 406 to transmit first wireless data in one or more resource blocks utilized by the second UE 414b and configure base station 2 408 to not transmit the first wireless data or second wireless data in the one or more resource blocks.

In the illustrated example, a third UE 414c is within the first boundary 416, a second boundary 418, a third boundary 420 associated with base station 3 410, and a fourth boundary 422 associated with base station 4 412. For example, the third UE 414c may be positioned such that the third UE 414c is within the first boundary 416, the second boundary 418, the third boundary 420, and the fourth boundary 422. In some embodiments, the DU/CU server 404 can configure base station 1 406, base station 2 408, base station 3 410, and base station 4 412 to be in communication with the third UE 414c. For example, the DU/CU server 404 can configure base station 1 406, base station 2 408, base station 3 410, and base station 4 412 to transmit the same wireless data (e.g., the same data payload), such as duplicate signals, to the third UE 414c. In some embodiments, the DU/CU server 404 can configure base station 1 406 to transmit first wireless data in one or more resource blocks utilized by the third UE 414c and configure the other base stations to not transmit the first wireless data or any other wireless data in the one or more resource blocks.

Beneficially, the DU/CU server 404 may configure the supercell 400 such that no handover is required when the UEs 414a, 414b, 414c move across small cell boundaries (e.g., moving from the first boundary 416 to the second boundary 418). Beneficially, the UEs 414a, 414b, 414c at the small cell boundaries (e.g., at an intersection of two or more boundaries of base station 1 406, base station 2 408, base station 3 410, and/or base station 4 412) may benefit from the receptions of signal transmitted from multiple small cells. Beneficially, peak rates and user counts may grow by N where N is the number of small cells in the supercell 400.

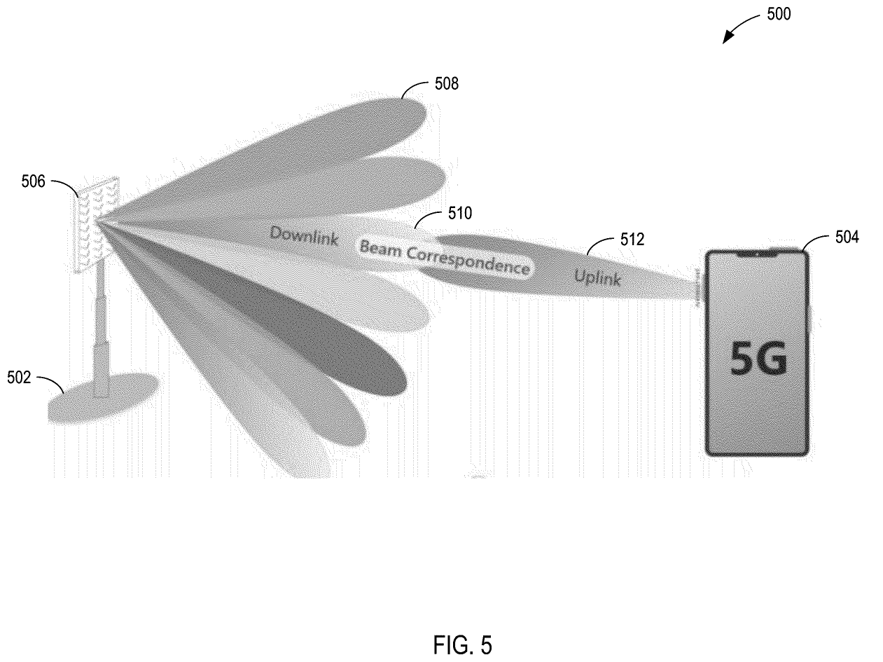

FIG. 5 is an illustration of a base station 502 performing beam sweeping to facilitate communication with a cellular device 504. The base station 502 of this example can be a base station, such as one of the base stations 306, 308, 310, 312 of FIG. 3 and/or one of the base stations 406, 408, 410, 412 of FIG. 4. The base station 502 of this example has an antenna array 506 configurable to sequentially broadcast and/or transmit reference signals in different directions. In some embodiments, the reference signals can be representative of a plurality of synchronization signal blocks (SSBs). In some embodiments, the plurality of SSBs can include at least one of a primary synchronization signal (PSS) or a secondary synchronization signal (SSS), a physical broadcast channel (PBCH), or a demodulation reference signal (DMRS) for PBCH. In some embodiments, the reference signals can be representative of a plurality of channel state information reference signals (CSI-RSs).

In some embodiments, the base station 502 and/or the cellular device 504 may effectuate beam management in accordance with a set of beam management procedures for 5G NR as defined by 3GPP that are applicable for an idle mode (e.g., an idle mode of operation) or a connected mode (e.g., a connected mode of operation). In some embodiments, idle mode refers to when the cellular device 504 does not have active data transmission. For example, idle mode procedure can be used when the cellular device 504 is trying to connect to a network for the first time while switching on or reinitiating connection after waking up. In some embodiments, beam management in idle mode can assist the establishing of a directional initial access. In some embodiments, connected mode refers to when active data exchange is taking place between the base station 502 and the cellular device 504 and the cellular device 504 is moving within the cell implemented by the base station 502.

In some embodiments, beam management is a set of Layer 1 (PHY) and Layer 2 (MAC) procedures to establish and retain an optimal beam pair for good connectivity. A beam pair consists of a transmit beam and a corresponding receive beam in one link direction. Before the cellular device 504 can communicate with a network, the cellular device 504 may perform cell search and selection procedures and obtain initial cell synchronization and system information. The process may include acquiring frame synchronization, identifying the cell identity, and decoding the master information block (MIB) and the system information block (SIB1). In a multi-antenna system implementation that transmits multiple beams, the cellular device 504 may attempt to detect all of the beams in the search space and thereby attempt to detect all of the beams from a particular base station, such as the base station 502.

In some embodiments, the base station 502 may perform beam sweeping during initial network access by the cellular device 504 such that the cellular device 504 may select the best beam. The base station 502 may perform beam sweeping by transmitting beams in different directions in a burst at regular defined intervals. When synchronizing with the network, the cellular device 504 may read the SSB and extract at least one of the PSS, the SSS, the PBCH, or the DMRS. In some embodiments, the PSS may be one of three possible sequences and provide a timing estimate. In some embodiments, the SSS may be one of 336 possible sequences and provide a cell (or cellular) identifier (ID). In some embodiments, the PBCH and the DMRS may include the MIB and basic information to advance in the process, which may be to decode the system information block (SIB)-1.

In some embodiments, a single SS block may span four orthogonal frequency-division multiplexing (OFDM) symbols in time and 240 subcarriers in frequency (20 resource blocks). Alternatively, a single SS block may span any other number of OFDM symbols in time. Alternatively, a single SS block may span any other number of subcarriers in frequency. In some embodiments, each SS block can correspond to a specific beam, beamformed in a different direction. For example, a group of SS blocks can form one SS burst set that spans a time window (e.g., a 5 millisecond (ms) time window or any other time window). In some embodiments, the SS burst can be repeated periodically with a specified period (e.g., a period of 20 ms or any other period). In some embodiments, the maximum number of SS blocks in a SS burst set can be dependent on the operating frequency range.

In some embodiments, the base station 502 may transmit a plurality of reference signals via respective ones of a plurality of beams 508. The cellular device 504 may receive and process the reference signals from the base station 502. For example, the cellular device 504 may measure the beam strength for respective ones of the plurality of beams 508. In some embodiments, the cellular device 504 may measure the beam strength by measuring received signal power, such as by measuring received signal power of a signal transmitted by one of the plurality of beams 508. In some embodiments, such as when the cellular device 504 is in idle mode, the cellular device 504 can determine and/or measure the beam strength based on the synchronization signals (e.g., PSS, SSS). In some embodiments, such as when the cellular device 504 is in connected mode, the cellular device 504 can determine and/or measure the beam strength based on the CSI-RS and/or SSB. In some embodiments, the cellular device 504 can identify the best of the plurality of beams 508 using predefined threshold criteria defined by the base station 502. In some embodiments, the predefined threshold criteria can include at least one threshold, such as a threshold amount, quantity, and/or level of reference signal received power (RSRP). For example, the cellular device 504 can identify the first beam 510 as the best beam of the plurality of beams 508 after a determination that the first beam 510 has the highest RSRP. In some embodiments, the RSRP of the first beam 510 satisfies an RSRP threshold, such as by meeting and/or exceeding the RSRP threshold.

Based on the processed reference signals, the cellular device 504 may identify one or more beam indices that correspond to the best received beam(s), which is identified in FIG. 5 as a first beam 510. The cellular device 504 may report the one or more beam indices to a centralized location, such as an O-DU via the base station 502. For example, the cellular device 504 may transmit a physical random access channel (PRACH) preamble corresponding to the SS block for which the best beam (e.g., the first beam 510) was identified. In some embodiments, there is a one-to-one mapping between the received SS block and the transmitted PRACH preamble. A random access channel (RACH) is an uplink channel used during initial access or when the cellular device 504 is out of sync with the network and needs to establish (reestablish) synchronization. In some embodiments, such as when the cellular device 504 is in idle mode and after the cellular device 504 has selected the first beam 510, there is one or more RACH intervals for the cellular device 504 with a certain time and frequency offset, which the cellular device 504 can transmit the PRACH preamble.

The O-DU may identify one or more base stations that correspond to the one or more beam indices. For example, the O-DU may identify the base station 502 as corresponding to the beam index obtained from the cellular device 504. The O-DU may configure the base station 502 to communicate with the cellular device 504. For example, the base station 502 can transmit wireless data to the cellular device 504. The O-DU may configure the cellular device 504 to communicate with the base station 502 via the first beam 510, which is a downlink beam, and a second beam 512, which is an uplink beam.

In some embodiments, the first beam 510 may exhibit poor channel condition and thereby cause beam failure. In some embodiments, in response to beam failure, the cellular device 504 can perform a beam recovery process to obtain a new beam. For example, the cellular device 504 can select the next best beam of the plurality of beams 508 by transmitting a random access (RA) preamble, which may be sent in the PRACH, after the beam failure. In some embodiments, if the first attempt of RA procedure fails, the cellular device 504 can switch to another one of the plurality of beams 508 for another RA procedure. In response to a successful RA, the cellular device 504 can receive a downlink resource allocation and an uplink grant on the physical downlink control channel (PDCCH).

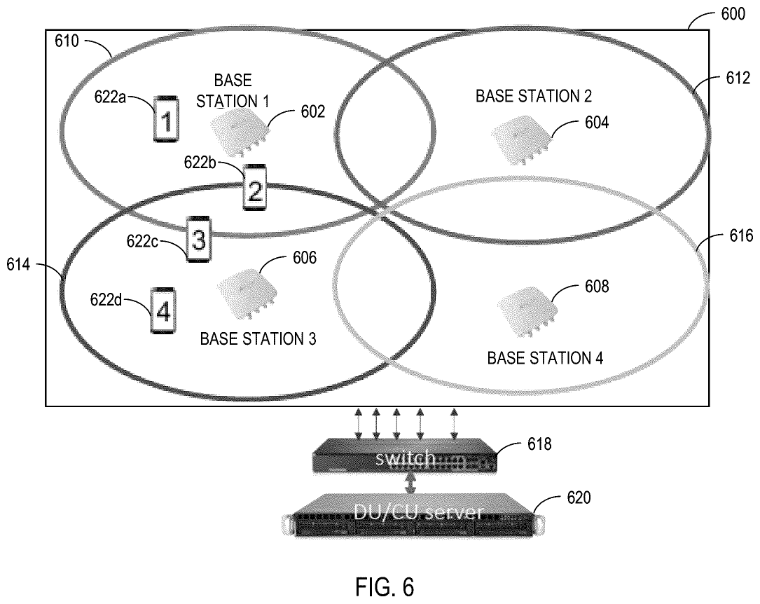

FIG. 6 is an illustration of configuring a base station in a supercell 600 using beam management, according to some embodiments. The supercell 600 of this example is instantiated, formed, and/or established by a combination of a first base station 602 (identified by base station 1), a second base station 604 (identified by base station 2), a third base station 606 (identified by base station 3), and a fourth base station 608 (identified by base station 4). In some embodiments, one(s) of the plurality of base stations 602, 604, 606, 608 can implement and/or correspond to one(s) of the RU(s) 102 of FIG. 1. For example, base station 1 602 can implement and/or correspond to a first one of the RU(s) 102, base station 2 604 can implement and/or correspond to a second one of the RU(s) 102, and so on.

Base station 1 602 of the illustrated example establishes and/or generates a first boundary 610. Base station 2 604 of the illustrated example establishes and/or generates a second boundary 612. Base station 3 606 of the illustrated example establishes and/or generates a third boundary 614. Base station 4 608 of the illustrated example establishes and/or generates a fourth boundary 616.

The supercell 600 of the illustrated example is coupled (e.g., physically coupled, communicatively coupled) to a switch 618, which is in turn coupled to a DU and/or CU server 620. Alternatively, the supercell 600 may be coupled to the DU/CU server 620 without routing data through the switch 618 such that the supercell 600, or portion(s) thereof, may be directly coupled to the DU/CU server 620. In some embodiments, the supercell 600 can implement the supercell 103 of FIG. 1. In some embodiments, the switch 618 can implement the switch 104 of FIG. 1. In some embodiments, the DU and/or CU server 620 can implement the DU 106 and/or the CU 108 of FIG. 1. For example, the DU/CU server 620 can include and/or implement a DU server, a CU server, and/or a combination thereof. For example, the DU/CU server 620 can include and/or implement the DU 106, the CU 108, and/or a combination thereof. In some embodiments, the DU/CU server 620 can form the supercell 600 by combining and/or grouping the plurality of base stations 602, 604, 606, 608.

One(s) of the base stations 602, 604, 606, 608 of this example is/are in communication with one(s) of a plurality of UEs 622a, 622b, 622c, 622d. The UEs 622a, 622b, 622c, 622d of this example may be a cellular device but may be any other type of electronic device. For example, one or more of the UEs 622a, 622b, 622c, 622d may be smartphones and one or more of the UEs 622a, 622b, 622c, 622d may be autonomous equipment, IoT devices, or the like.

In some prior beam management approaches, a single base station may be configured to sequentially transmit all of the beams for selection by a UE such that the UE selects one of the beams from the single base station (instead of from a plurality of base stations). Beneficially, the embodiments disclosed herein improves on such prior approaches by configuring a plurality of base stations to transmit their own respective beam(s) such that the UE can select one(s) of the respective beam(s) from a plurality of base stations. In some such embodiments, the UE can switch from beam to beam from the perspective of the UE while switching from base station to base station from the perspective of the base stations. Beneficially, the UE can quickly switch beams (and thereby may quickly switch base stations, or gNBs in 3GPP implementations) without a conventional base station handover process needing to be completed. In response to the UE selecting one(s) of the respective beam(s) for communication, the DU/CU server 620 can configure the base station(s) corresponding to the selected beam(s) to communicate with the UE using the selected beam(s).

In the illustrated example, a first UE 622a (identified by 1) of the plurality of UEs 622a, 622b, 622c, 622d is within the first boundary 610. In example operation, the DU/CU server 620 can configure base station 1 602 to communicate with UE 622a. In example operation, the DU/CU server 620 can configure UE 622a to communicate with base station 1 602.

In example operation, UE 622a (or a user associated with UE 622a and moving with UE 622a) can move to a position of a second UE 622b (identified by 2) of the plurality of UEs 622a, 622b, 622c, 622d. At this position, UE 622a is within and/or at the first boundary 610 and the third boundary 614. In some embodiments, base station 1 602 and base station 3 606 can sequentially transmit (e.g., periodically sequentially transmit) beams in a plurality of directions. UE 622a can determine that, when at the position of UE 622b, a first beam transmitted from base station 1 602 has a higher beam strength than a second beam transmitted from base station 3 606 at least in part due to UE 622a being closer in geographical distance to base station 1 602, having fewer obstacles in between base station 1 602 and UE 622a, etc., and/or any combination(s) thereof. In example operation, UE 622a can report a beam index corresponding to the first beam to the DU/CU server 620 via a data path that may include (i) base station 1 602 and/or base station 3 606 and (ii) the switch 618. In example operation, the DU/CU server 620 can configure UE 622a and base station 1 602 to communicate with each other via the first beam. For example, the DU/CU server 620 can cause UE 622a to configure itself for communication by using the beam index. For example, the DU/CU server 620 can push a MAC command or an RRC control command to UE 622a to configure itself using the beam index.

In some embodiments, the DU/CU server 620 can configure base station 1 602 to transmit signals to UE 622a using a set of resource blocks and configure base station 3 606 to avoid transmitting signals to UE 622a using the set of resource blocks. Additionally or alternatively, the DU/CU server 620 can configure base station 1 602 and base station 3 606 to transmit duplicate signals to UE 622a such that the duplicate signals are added up constructively at UE 622a. For example, UE 622a can receive duplicative signals and respond by transmitting the same wireless data to base station 1 602 and base station 3 606 such that base station 1 602 and base station 3 606 independently decode the received wireless data. In some embodiments, base station 1 602 and base station 3 606 can provide the decoded wireless data to the DU/CU server 620 (via the switch 618). In some embodiments, the DU/CU server 620 may process both of the decoded wireless data. In some embodiments, the DU/CU server 620 may process the decoded wireless data that is received first in time and discard the decoded wireless data that is subsequently received. In some embodiments, the DU/CU server 620 may process the decoded wireless data from one base station and discard the non-decoded wireless data from another base station.

In example operation, UE 622a (or a user associated with UE 622a and moving with UE 622a) can move to a position of a third UE 622c (identified by 3) of the plurality of UEs 622a, 622b, 622c, 622d. At this position, UE 622a is within and/or at the first boundary 610 and the third boundary 614. In some embodiments, base station 1 602 and base station 3 606 can sequentially transmit (e.g., periodically sequentially transmit) beams in a plurality of directions. UE 622a can determine that, when at the position of UE 622c, a first beam transmitted from base station 3 606 has a higher beam strength than a second beam transmitted from base station 1 602 at least in part due to UE 622a being closer in geographical distance to base station 3 606, having fewer obstacles in between base station 3 606 and UE 622a, etc., and/or any combination(s) thereof. In example operation, UE 622a can report a beam index corresponding to the first beam to the DU/CU server 620 via a data path that may include (i) base station 3 606 and/or base station 1 602 and (ii) the switch 618. In example operation, the DU/CU server 620 can configure UE 622a and base station 3 606 to communicate with each other via the first beam. For example, the DU/CU server 620 can cause UE 622a to configure itself for communication by using the beam index. For example, the DU/CU server 620 can push a MAC command or an RRC control command to UE 622a to configure itself using the beam index.

Additionally or alternatively, the DU/CU server 620 can configure base station 1 602 and base station 3 606 to transmit duplicate signals to UE 622a such that the duplicate signals are added up constructively at UE 622a. In some embodiments, the DU/CU server 620 can configure base station 3 606 to transmit signals to UE 622a using a set of resource blocks and configure base station 1 602 to avoid transmitting signals to UE 622a using the set of resource blocks.

Beneficially, UE 622a can switch from communicating with base station 1 602 to communicating with base station 3 606 using beam management processes and/or techniques with no handover performed. For example, UE 622a can switch from base station 1 602 to base station 3 606 in response to MAC layer command(s) or RRC control command(s) generated at least in part due to beam analysis and evaluation. Beneficially, switching between base stations using beam management as disclosed herein can improve signal continuity, improve throughput, and/or reduce latency compared to conventional cellular networks that may employ base station handover techniques.

In the illustrated example, a fourth UE 622d (identified by 4) of the plurality of UEs 622a, 622b, 622c, 622d is within the third boundary 614 (e.g., only within the third boundary 614). In example operation, UE 622d can detect beams from base station 3 606 and identify one of the detected beams as the best beam, such that the best beam has the highest beam strength of the beams and/or has a beam strength that meets and/or exceeds a beam strength threshold. In example operation, after a receipt of a beam index corresponding to the best beam identified by UE 622d, the DU/CU server 620 can configure base station 3 606 to communicate with UE 622d. In example operation, the DU/CU server 620 can configure UE 622d to communicate with base station 3 606 by issuing a MAC layer command or an RRC control command.

In some embodiments, a UE, such as UE 622a, can move to an intersection of more than two boundaries. For example, UE 622a can be positioned such that UE 622a is located and/or positioned within three or more of the boundaries 610, 612, 614, 616. In some embodiments, UE 622a can detect a beam having the highest beam strength from a plurality of beams transmitted by the base stations 602, 604, 606, 608. UE 622a can report a beam index corresponding to the detected beam having the highest beam strength to the DU/CU server 620 via the switch 618. In some embodiments, UE 622a can detect one or more beams having the beam strength exceeding a threshold from a plurality of beams transmitted by the base stations 602, 604, 606, 608. UE 622a can report one or more beam indices corresponding to the detected beams having the beam strength exceeding a threshold to the DU/CU server 620 via the switch 618. The DU/CU server 620 can analyze and/or evaluate a policy, such as a network policy, to identify the coordination of the base stations 602, 604, 606, 608. For example, the DU/CU server 620 can determine that the network policy indicates that duplicate signals are to be transmitted from one(s) of the base stations 602, 604, 606, 608 to a UE, such as UE 622a. In some embodiments, the DU/CU server 620 can determine that the network policy is indicative of a UE communicating with a single one of the base stations 602, 604, 606, 608 such that the UE communicates with a base station associated with the best beam as described herein.

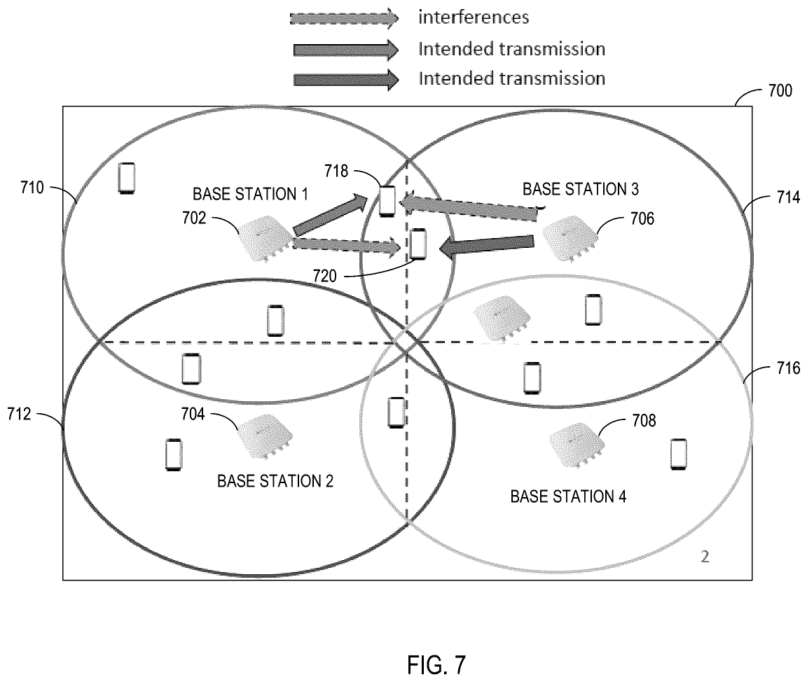

FIG. 7 is an illustration of a conventional base station handover technique for a cellular network 700. The cellular network 700 of this example includes a plurality of base stations 702, 704, 706, 708 respectively identified by base station 1, base station 2, base station 3, and base station 4. The plurality of base stations 702, 704, 706, 708 have corresponding cell boundaries 710, 712, 714, 716.

In the illustrated example, a first UE 718 is within a first cell boundary 710 associated with base station 1 702 and a third cell boundary 714 associated with base station 3 706. In this example, base station 1 702 and the first UE 718 are configured to communicate with each other. The first UE 718 in this example is experiencing inter-cell interference because the first UE 718 is receiving transmissions from base station 3 706 that are intended for a second UE 720. Likewise, the second UE 720 is subject to inter-cell interference because the second UE 720 is receiving transmissions from base station 1 702 that are intended for the first UE 718.

Beneficially, the technology developed by the inventors as disclosed herein overcome the inter-cell interference challenges depicted in FIG. 7. For example, by establishing a supercell, such as the supercell 600 of FIG. 6, inter-cell interference is eliminated and/or otherwise reduced. In another example, by configuring a UE to switch communication between base stations using beam management instead of handovers, the UE can achieve improved signal continuity, increased throughput, and reduced latency.

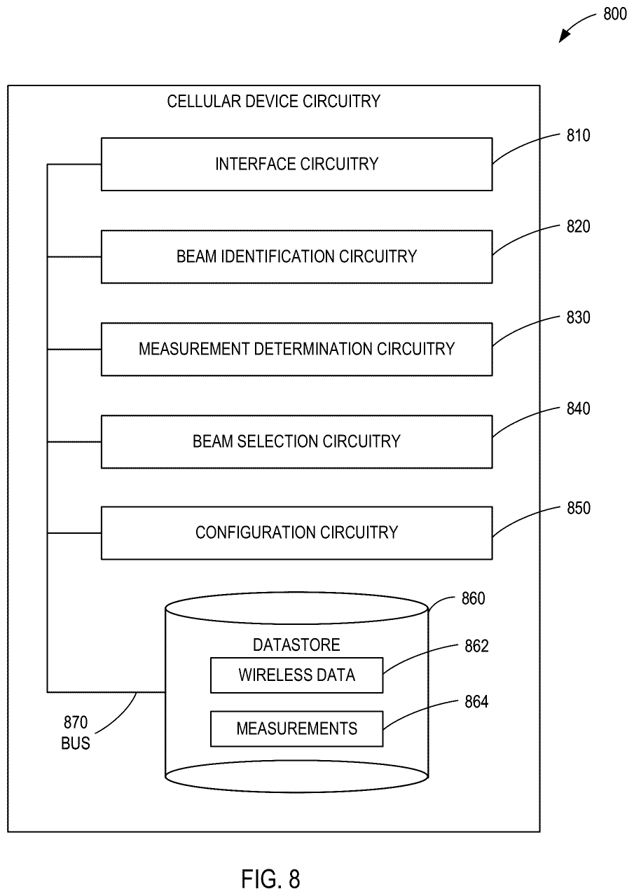

FIG. 8 is a block diagram of example cellular device circuitry 800. In some embodiments, the cellular device circuitry 800 can implement and/or correspond to one(s) of the UEs 114 of FIG. 1, the UE 314 of FIG. 3, one(s) of the UEs 414a, 414b, 414c of FIG. 4, the cellular device 504 of FIG. 5, and/or one(s) of the UEs 622a, 622b, 622c, 622d of FIG. 6. The cellular device circuitry 800 of FIG. 8 includes interface circuitry 810, beam identification circuitry 820, measurement determination circuitry 830, beam selection circuitry 840, configuration circuitry 850, and a datastore 860. Component(s) of the cellular device circuitry 800 can be in communication with one(s) of each other via a bus 870. For example, the bus 870 can be any type of computing and/or electrical bus, such as an Inter-Integrated Circuit (I2C) bus, a Peripheral Component Interconnect (PCI) bus, a Peripheral Component Interconnect Express (PCIe) bus, a Serial Peripheral Interface (SPI) bus, and/or the like.

In the illustrated example, the cellular device circuitry 800 includes the interface circuitry 810 to receive and/or transmit wireless data. For example, the interface circuitry 810 can receive reference signals from a base station as disclosed herein. In some embodiments, the interface circuitry 810 can receive signals via a beam and/or transmit signals via the beam. In some embodiments, the interface circuitry 810 can cause transmission of data to a DU, such as by providing a beam index or any other data to the DU (either directly or indirectly via one or more devices such as a switch).

In the illustrated example, the cellular device circuitry 800 includes the beam identification circuitry 820 to identify a beam associated with a base station. For example, the beam identification circuitry 820 can receive a reference signal transmitted by a base station. The beam identification circuitry 820 can determine that the reference signal includes and/or is representative of beam identification data, such as a beam index.

In the illustrated example, the cellular device circuitry 800 includes the measurement determination circuitry 830 to calculate and/or determine a measurement based on one or more reference signals. For example, the measurement determination circuitry 830 can determine a beam strength of the one or more reference signals.

In the illustrated example, the cellular device circuitry 800 includes the beam selection circuitry 840 to select one or more beams for communication. For example, the beam selection circuitry 840 can select a first beam as having a measurement, such as a beam strength (but any other measurement is contemplated), that is higher than measurements for other beams. In some embodiments, the beam selection circuitry 840 can select the first beam based on the measurement meeting and/or exceeding a threshold (e.g., a measurement threshold) and thereby satisfying the threshold. In some embodiments, the beam selection circuitry 840 can select a plurality of beams after a determination that ones of the plurality of beams respectively have a measurement that satisfies a threshold.

In the illustrated example, the cellular device circuitry 800 includes the configuration circuitry 850 to configure a cellular device. For example, the configuration circuitry 850 can configure the interface circuitry 810 to communicate with one or more base stations using one or more beams. In some embodiments, the configuration circuitry 850 can configure the interface circuitry 810 using one or more beam indices corresponding to the one or more beams to facilitate the communication. Any other configuration of a cellular device may be performed by the configuration circuitry 850.

In the illustrated example, the cellular device circuitry 800 includes the datastore 860 to record and/or store data. In this example, the datastore 860 records, stores, and/or includes wireless data 862 and measurements 864. Additionally or alternatively, the datastore 860 may record, store, and/or include any other data. In some embodiments, the wireless data 862 may include reference signals, beam identification information such as a beam index, a network policy, etc., and/or any combination(s) thereof. In some embodiments, the measurements 864 may include any type of cellular measurement such as a beam strength, an angle-of-arrival, a time-of-arrival, etc.

In some embodiments, the datastore 860 can be implemented by any technology for storing data. For example, the datastore 860 can be implemented by a volatile memory (e.g., a Synchronous Dynamic Random Access Memory (SDRAM), a Dynamic Random Access Memory (DRAM), a RAMBUS Dynamic Random Access Memory (RDRAM), etc.) and/or a non-volatile memory (e.g., flash memory). The datastore 860 may additionally or alternatively be implemented by one or more double data rate (DDR) memories, such as DDR, DDR2, DDR3, DDR4, mobile DDR (mDDR), etc. The datastore 860 may additionally or alternatively be implemented by one or more mass storage devices such as hard disk drive(s) (HDD(s)), compact disk (CD) drive(s), digital versatile disk (DVD) drive(s), solid-state disk (SSD) drive(s), etc. While in the illustrated example the datastore 860 is illustrated as a single datastore, the datastore 860 may be implemented by any number and/or type(s) of datastore. Furthermore, the data stored in the datastore 860 may be in any data format. Non-limiting examples of data formats include a flat file, binary data, comma delimited data, tab delimited data, and structured query language (SQL) structures.

In some embodiments, the datastore 860 may be implemented by a database system, such as one or more databases. The term “database” as used herein means an organized body of related data, regardless of the manner in which the data or the organized body thereof is represented. For example, the organized body of related data may be in the form of one or more of a table, a log, a map, a grid, a packet, a datagram, a frame, a file, an e-mail, a message, a document, a report, a list or in any other form.

While an example implementation of the cellular device circuitry 800 is depicted in FIG. 8, other implementations are contemplated. For example, one or more blocks, components, functions, etc., of the cellular device circuitry 800 may be combined or divided in any other way. The cellular device circuitry 800 of the illustrated example may be implemented by hardware alone, or by a combination of hardware, software, and/or firmware. For example, the cellular device circuitry 800 may be implemented by one or more analog or digital circuits (e.g., comparators, operational amplifiers, etc.), one or more hardware-implemented state machines, one or more programmable processors (e.g., central processing units (CPUs), digital signal processors (DSPs), field programmable gate arrays (FPGAs), etc.), one or more network interfaces (e.g., network interface circuitry, network interface cards (NICs), smart NICs, etc.), one or more application specific integrated circuits (ASICs), one or more memories (e.g., non-volatile memory, volatile memory, etc.), one or more mass storage disks or devices (e.g., hard-disk drives (HDDs), solid-state disk (SSD) drives, etc.), etc., and/or any combination(s) thereof. The cellular device circuitry 800 of the illustrated example is implemented as a single, physical hardware device, such as being in the same electrical enclosure, housing, etc. Alternatively, one or more portions of the cellular device circuitry 800 may be implemented as two or more separate physical hardware devices.

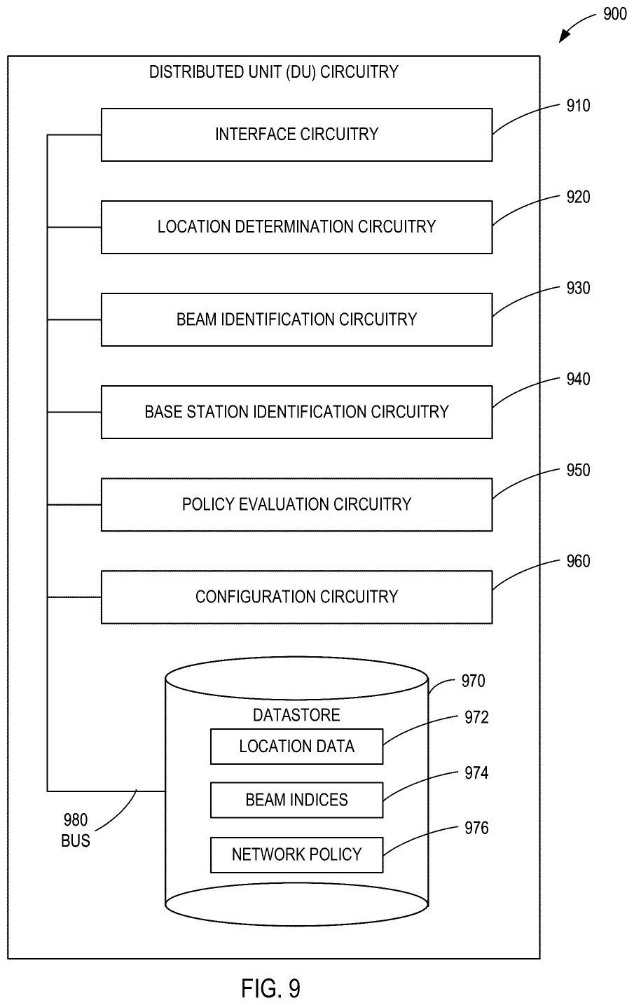

FIG. 9 is a block diagram of example distributed unit (DU) circuitry 900. In some embodiments, the DU circuitry 900 can implement and/or correspond to the DU 106 of FIG. 1, the centralized CU and DU 216 of FIG. 2, the DU/CU server 304, the DU/CU server 404, and the DU/CU server 620. The DU circuitry 900 of FIG. 9 includes interface circuitry 910, location determination circuitry 920, beam identification circuitry 930, base station identification circuitry 940, policy evaluation circuitry 950, configuration circuitry 960, and a datastore 970. The datastore 970 of this example includes location data 972, beam indices 974, and a network policy 976 (or a plurality of network policies). Component(s) of the DU circuitry 900 can be in communication with one(s) of each other via a bus 980. For example, the bus 980 can be any type of computing and/or electrical bus, such as an I2C bus, a PCI bus, a PCIe bus, a SPI bus, and/or the like.

The DU circuitry 900 includes the interface circuitry 910 to receive and/or transmit wireless data. For example, the interface circuitry 910 can receive a beam index from a cellular device as disclosed herein. In some embodiments, the interface circuitry 910 can cause transmission of data to a cellular device, such as by providing a configuration, a MAC layer command, an RRC control command, or any other data to the cellular device (either directly or indirectly via one or more devices such as a switch).

The DU circuitry 900 includes the location determination circuitry 920 to determine a location of a UE. For example, the location determination circuitry 920 can utilize any location determination technique such as a technique based on at least one of time-of-arrival (TOA), time-difference-of-arrival (TDOA), or angle-of-arrival (AOA). In some embodiments, the location determination circuitry 920 can obtain location and/or position data from a UE and store the location/position data as the location data 972. In some embodiments, the location determination circuitry 920 can process wireless data from a UE and/or a base station and determine a location of the UE based on the processed wireless data. In some embodiments, the location determination circuitry 920 can store the location of the UE as part of the location data 972.

The DU circuitry 900 includes the beam identification circuitry 930 to identify a beam associated with a base station. For example, the beam identification circuitry 930 can receive a beam index obtained and/or reported from a UE and identify the beam index as corresponding to a base station.

The DU circuitry 900 includes the base station identification circuitry 940 to determine that the beam index corresponds to a base station that transmitted a beam to the UE. In some embodiments, the base station identification circuitry 940 can query a table (e.g., a mapping table, a look-up table, etc.) of associations of beam indices and base stations to identify an originating base station. In some embodiments, the beam indices 974 can include the beam index and/or the table.

The DU circuitry 900 includes the policy evaluation circuitry 950 to analyze, evaluate, and/or query a policy, such as a network policy, to determine a configuration of a UE and/or a base station. For example, the policy evaluation circuitry 950 can consult the network policy 976 to determine how to coordinate one or more base stations to communicate with one or more UE.

The DU circuitry 900 includes the configuration circuitry 960 to configure a cellular device and/or a base station. For example, the configuration circuitry 960 can configure multiple base stations to transmit duplicate signals to a UE such that the duplicate signals are constructively added at the UE. In some embodiments, the configuration circuitry 960 can configure a first base station to communicate with a UE while a second base station is not to communicate with the UE or, in some embodiments, communicate with the UE but on non-overlapping resources (e.g., non-overlapping resource blocks). In some embodiments, the configuration circuitry 960 can configure a UE with a beam index such that the UE communicates using a beam corresponding to the beam index.

In some embodiments, the configuration circuitry 960 can configure one or more base stations to communicate with a UE via a beam that corresponds to a beam index identified by the UE. Additionally or alternatively, a base station operating as a gNB may configure itself to communicate with a UE via a beam that corresponds to a beam index identified by a UE. For example, in response to the first UE 622a reporting beam(s) only corresponding to base station 1 602, the configuration circuitry 960 may configure the first UE 622a to communicate with base station 1 602. In some embodiments, the second UE 622b may report first beam(s) from base station 1 602 and second beam(s) from base station 3 606 as suitable for communication. In some such embodiments, the configuration circuitry 960 may coordinate operation of base station 1 602 and base station 3 606 such that base station 1 602 and/or base station 3 606 communicate with the second UE 622b.

The DU circuitry 900 includes the datastore 970 to record, store, and/or include data such as the location data 972, the beam indices 974, the network policy 976, and/or any other data. In some embodiments, the datastore 970 can be implemented by any technology for storing data. For example, the datastore 970 can be implemented by a volatile memory (e.g., an SDRAM, a DRAM, a RDRAM, etc.) and/or a non-volatile memory (e.g., flash memory). The datastore 970 may additionally or alternatively be implemented by one or more DDR memories, such as DDR, DDR2, DDR3, DDR4, mDDR, etc. The datastore 970 may additionally or alternatively be implemented by one or more mass storage devices such as HDD(s), CD drive(s), DVD drive(s), SSD drive(s), etc. While in the illustrated example the datastore 970 is illustrated as a single datastore, the datastore 970 may be implemented by any number and/or type(s) of datastore. Furthermore, the data stored in the datastore 970 may be in any data format. Non-limiting examples of data formats include a flat file, binary data, comma delimited data, tab delimited data, and SQL structures. In some embodiments, the datastore 970 may be implemented by a database system, such as one or more databases.

While an example implementation of the DU circuitry 900 is depicted in FIG. 9, other implementations are contemplated. For example, one or more blocks, components, functions, etc., of the DU circuitry 900 may be combined or divided in any other way. The DU circuitry 900 of the illustrated example may be implemented by hardware alone, or by a combination of hardware, software, and/or firmware. For example, the DU circuitry 900 may be implemented by one or more analog or digital circuits (e.g., comparators, operational amplifiers, etc.), one or more hardware-implemented state machines, one or more programmable processors (e.g., central processing units (CPUs), digital signal processors (DSPs), field programmable gate arrays (FPGAs), etc.), one or more network interfaces (e.g., network interface circuitry, NICs, smart NICs, etc.), one or more application specific integrated circuits (ASICs), one or more memories (e.g., non-volatile memory, volatile memory, etc.), one or more mass storage disks or devices (e.g., hard-disk drives (HDDs), solid-state disk (SSD) drives, etc.), etc., and/or any combination(s) thereof. The DU circuitry 900 of the illustrated example is implemented as a single, physical hardware device, such as being in the same electrical enclosure, housing, etc. Alternatively, one or more portions of the DU circuitry 900 may be implemented as two or more separate physical hardware devices.

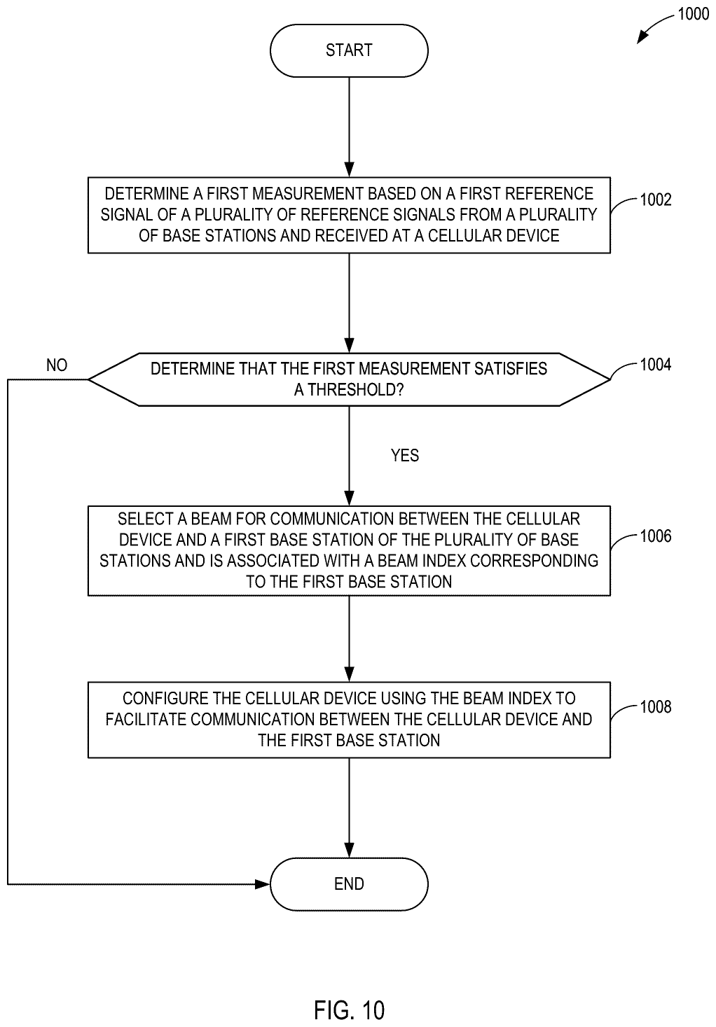

FIGS. 10-14 are flowcharts representative of machine-readable instructions that may be executed by processor circuitry to implement a cellular device, such as the cellular device circuitry 800 of FIG. 8, and/or a DU, such as the DU circuitry 900 of FIG. 9. Additionally or alternatively, block(s) of one(s) of the flowcharts of FIGS. 10, 11, 12, 13, and/or 14 may be representative of state(s) of one or more hardware-implemented state machines, algorithm(s) that may be implemented by hardware alone such as an ASIC, etc., and/or any combination(s) thereof.

FIG. 10 is a flowchart 1000 that may be executed to implement the cellular device circuitry 800 of FIG. 8 to configure a cellular device using beam management. The flowchart 1000 of FIG. 10 begins at block 1002, at which the cellular device circuitry 800 of FIG. 8 may determine a first measurement based on a first reference signal of a plurality of reference signals from a plurality of base stations and received at a cellular device. For example, the measurement determination circuitry 830 (FIG. 8) may determine a beam strength of a received beam representative of one or more reference signals from a base station.

At block 1004, the cellular device circuitry 800 may determine whether the first measurement satisfies a threshold. For example, the measurement determination circuitry 830 (FIG. 8) may select the beam after determining that the beam strength satisfies a beam strength threshold. In some embodiments, the measurement determination circuitry 830 may determine that multiple beams satisfy the beam strength threshold. In some such embodiments, the measurement determination circuitry 830 may identify one of the multiple beams as having the strongest beam strength.

If, at block 1004, the cellular device circuitry 800 determines that the first measurement does not satisfy a threshold, the flowchart 1000 of FIG. 10 concludes. Otherwise, control proceeds to block 1006, at which the cellular device circuitry 800 may select a beam for communication between the cellular device and a first base station of the plurality of base stations and is associated with a beam index corresponding to the first base station. For example, the beam selection circuitry 840 (FIG. 8) may select the beam from the base station for communication between the cellular device and the base station. In some embodiments, the beam selection circuitry 840 may select the beam as having the strongest beam strength out of one or more identified beams having a respective beam strength that satisfied the beam strength threshold.

At block 1008, the cellular device circuitry 800 may configure the cellular device using the beam index to facilitate communication between the cellular device and the first base station. For example, the configuration circuitry 850 (FIG. 8) may configure the cellular device using the beam index such that the cellular device can communicate with the base station using the beam that corresponds to the beam index. After configuring the cellular device at block 1008, the flowchart 1000 of FIG. 10 concludes.

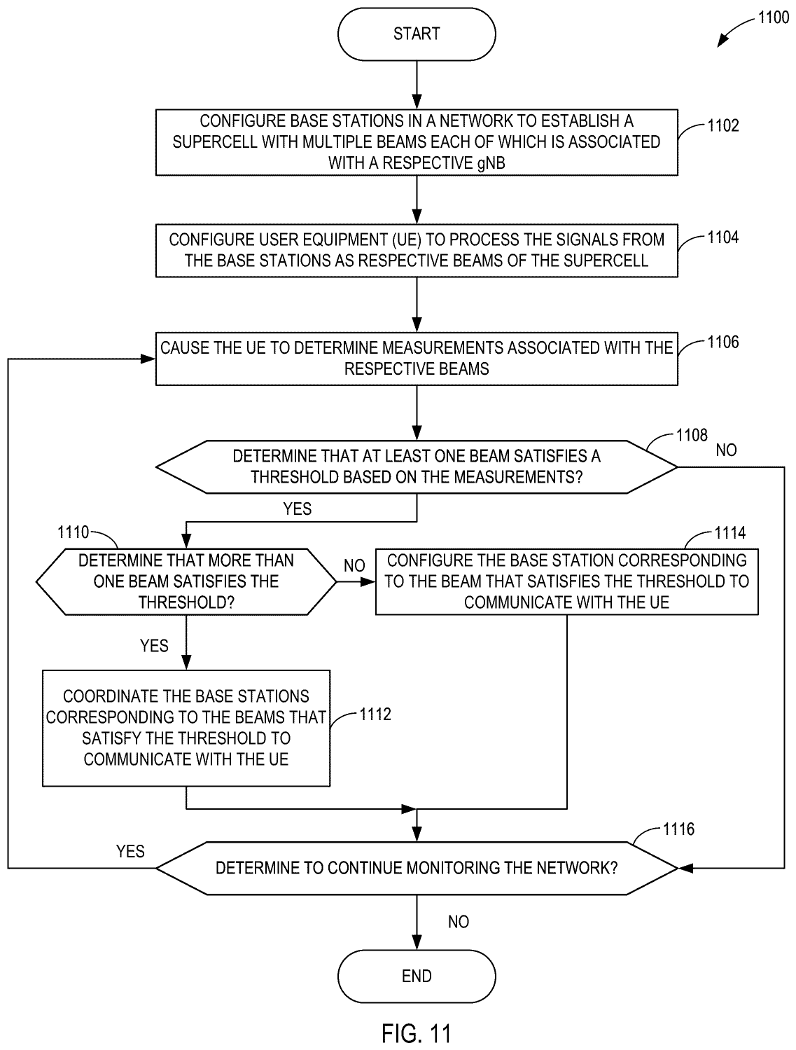

FIG. 11 is a flowchart 1100 that may be executed to implement the cellular device circuitry 800 of FIG. 8 and/or the DU circuitry 900 of FIG. 9 to configure base station(s) to communicate with a cellular device in a supercell. The flowchart 1100 of FIG. 11 begins at block 1102, at which the DU circuitry 900 may configure base stations in a network to establish a supercell with multiple beams, each of which is associated with one specific gNB. For example, the configuration circuitry 960 (FIG. 9) may configure a plurality of base stations to operate as a supercell with multiple beams.

At block 1104, the DU circuitry 900 may configure user equipment (UE) to process the signals from the base stations as respective beams of the supercell. For example, the configuration circuitry 960 may configure one or more UEs within and/or associated with the supercell to process signals, such as reference signals, signals representative of wireless data, etc., as beams.

At block 1106, the DU circuitry 900 may cause the UE to determine measurements associated with the respective beams. For example, the configuration circuitry 960 may configure the UE to determine at least one measurement, such as a beam strength, for one or more received beams.

At block 1108, the cellular device circuitry 800 may determine that at least one beam satisfies a threshold based on the measurements. For example, the interface circuitry 810 (FIG. 8) may receive a plurality of beams from a plurality of base stations and determine whether at least one of the plurality of beams has a beam strength that satisfies a threshold, such as a beam strength threshold.

If, at block 1108, the cellular device circuitry 800 determines that none of the beams satisfy a threshold based on the measurements, control proceeds to block 1116. Otherwise, control proceeds to block 1110, at which the cellular device circuitry 800 determines whether more than one beam satisfies the threshold.

If, at block 1110, the cellular device circuitry 800 determines that more than one beam satisfies the threshold, control proceeds to block 1112, at which the DU circuitry 900 coordinates the base stations corresponding to the beams that satisfy the threshold to communicate with the UE. For example, the interface circuitry 810 may provide the beam indices corresponding to the beams to the DU circuitry 900. In some embodiments, the configuration circuitry 960 may configure the base stations that correspond to the beams to facilitate communication with the cellular device circuitry 800 in accordance with the network policy 976 (FIG. 9).

If, at block 1110, the cellular device circuitry 800 determines that only one beam satisfies the threshold, control proceeds to block 1114, at which the DU circuitry 900 configures the base station corresponding to the beam that satisfies the threshold to communicate with the UE. For example, the configuration circuitry 960 may configure the base station corresponding to the beam to facilitate communication with the cellular device circuitry 800.

After block 1112 and/or block 1114, control proceeds to block 1116, at which the cellular device circuitry 800 and/or the DU circuitry 900 determine whether to continue monitoring the network. For example, the interface circuitry 810 (FIG. 8) may periodically determine to detect available beams. In some embodiments, the interface circuitry 910 (FIG. 9) may determine whether one or more beam indices have been received such that a cellular device is to switch beams for improved communication in the cellular network. If, at block 1116, the cellular device circuitry 800 and/or the DU circuitry 900 determine to continue monitoring the network, control returns to block 1106, otherwise the flowchart 1100 of FIG. 11 concludes.

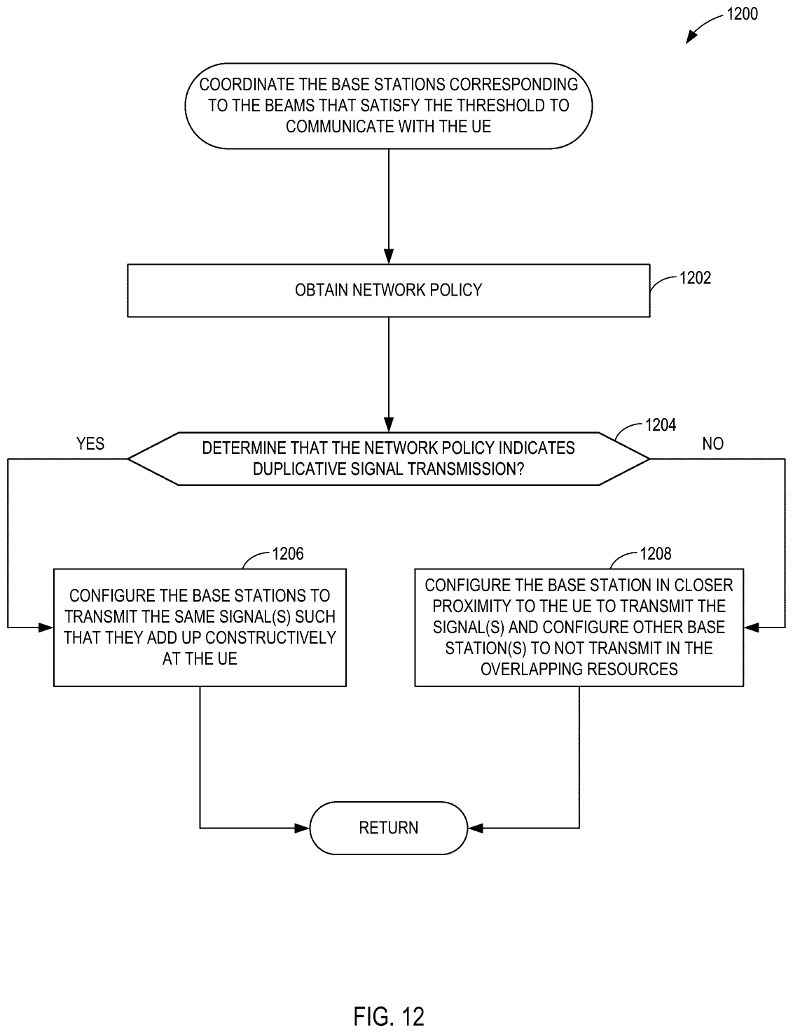

FIG. 12 is a flowchart 1200 that may be executed to implement the DU circuitry 900 of FIG. 9 to coordinate the base stations corresponding to the beams that satisfy the threshold to communicate with the UE. In some embodiments, the flowchart 1200 of FIG. 12 may be executed to implement block 1112 of the flowchart 1100 of FIG. 11. The flowchart 1200 of FIG. 12 begins at block 1202, at which the DU circuitry 900 may obtain a network policy. For example, the policy evaluation circuitry 950 (FIG. 9) may retrieve and/or evaluate the network policy 976 (FIG. 9).

At block 1204, the DU circuitry 900 may determine whether the network policy indicates duplicative signal transmission. If, at block 1204, the DU circuitry 900 determines that the network policy indicates duplicative signal transmission, control proceeds to block 1206.

At block 1206, the DU circuitry 900 may configure the base stations to transmit the same signal(s) such that they add up constructively at the UE. For example, the configuration circuitry 960 (FIG. 9) may configure a plurality of base stations to transmit the same and/or duplicate signals to the same UE such that the signals are added up constructively at the UE.

If, at block 1204, the DU circuitry 900 determines that the network policy does not indicate duplicative signal transmission, control proceeds to block 1208.

At block 1208, the DU circuitry 900 may configure the base station in closer proximity to the UE to transmit the signal(s) and configure other base station(s) to not transmit in the overlapping resources. For example, the configuration circuitry 960 may configure a first base station that is closer in position and/or location to a UE than a second base station to transmit signals to the UE.

After block 1206 and/or block 1208, the flowchart 1200 of FIG. 12 concludes. In some embodiments, the flowchart 1200 of FIG. 12 may return to block 1116 of FIG. 11 to determine whether to continue monitoring the network.

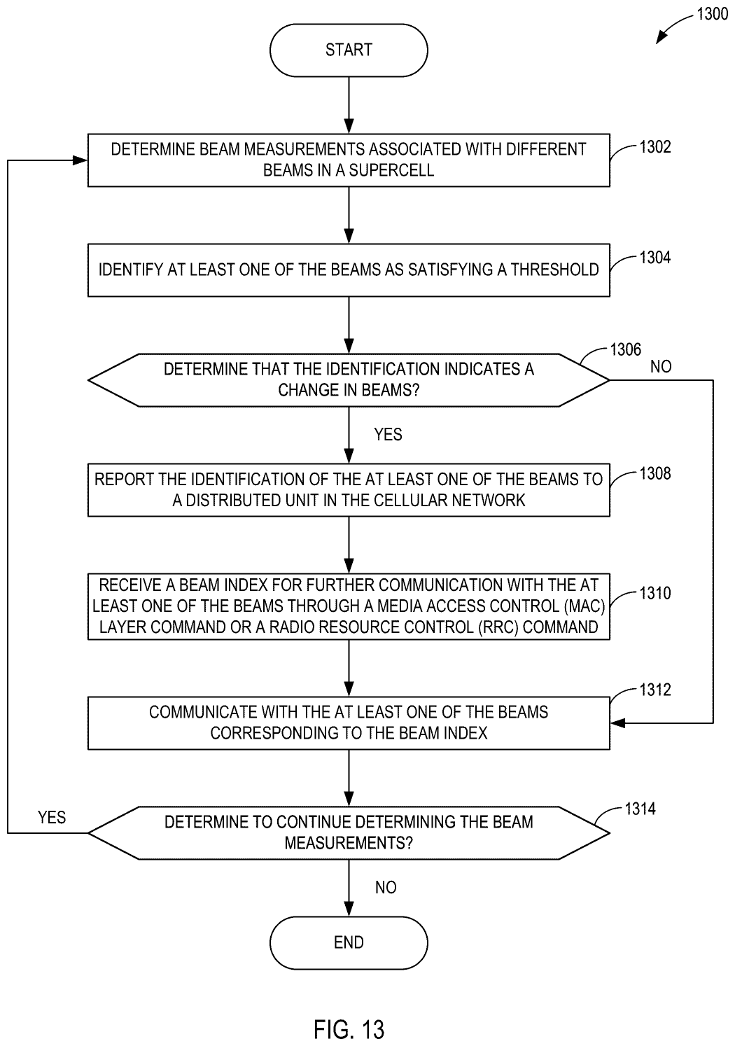

FIG. 13 is a flowchart 1300 that may be executed to implement the cellular device circuitry 800 of FIG. 8 to facilitate communication of the cellular device using one or more beams. The flowchart 1300 of FIG. 13 begins at block 1302, at which the cellular device circuitry 800 may determine beam measurements associated with different beams in a supercell. For example, the measurement determination circuitry 830 (FIG. 8) may determine beam measurements, such as a beam strength measurement, for a plurality of received beams in a supercell.

At block 1304, the cellular device circuitry 800 may identify at least one of the beams as satisfying a threshold. For example, the measurement determination circuitry 830 may determine that at least one of the received beams has a beam strength that satisfies a beam strength threshold.

At block 1306, the cellular device circuitry 800 may determine whether the identification indicates a change in beams. For example, the beam selection circuitry 840 (FIG. 8) may determine that the at least one of the received beams has a greater beam strength than a current beam in use, or, in some embodiments, a beam has not yet been used such that the cellular device circuitry 800 is operating in idle mode.

If, at block 1306, the cellular device circuitry 800 determines that the identification does not indicate a change in beams, control proceeds to block 1312. Otherwise, control proceeds to block 1308.

At block 1308, the cellular device circuitry 800 may report the identification of the at least one of the beams to a distributed unit in the cellular network. For example, the interface circuitry 810 (FIG. 8) may cause transmission of a beam index corresponding to the at least one identified beam to a distributed unit either directly or indirectly through one or more intermediary devices such as a gateway and/or switch.

At block 1310, the cellular device circuitry 800 may receive a beam index for further communication with the at least one of the beams through a media access control (MAC) layer command or a radio resource control (RRC) command. For example, in response to transmitting the beam index, the interface circuitry 810 may receive the beam index and/or an acknowledgment to proceed with using the beam index from the distributed unit via one or more MAC layer commands, RRC control commands, directions, instructions, etc.

At block 1312, the cellular device circuitry 800 may communicate with the at least one of the beams corresponding to the beam index. For example, the interface circuitry 810 may transmit wireless data to and/or receive wireless data from base station(s) that correspond to the beam index (or beam indices).

At block 1314, the cellular device circuitry 800 may determine whether to continue determining the beam measurements. If, at block 1314, the cellular device circuitry 800 determines to continue determining the beam measurements, control returns to block 1302. Otherwise, the flowchart 1300 of FIG. 13 concludes.

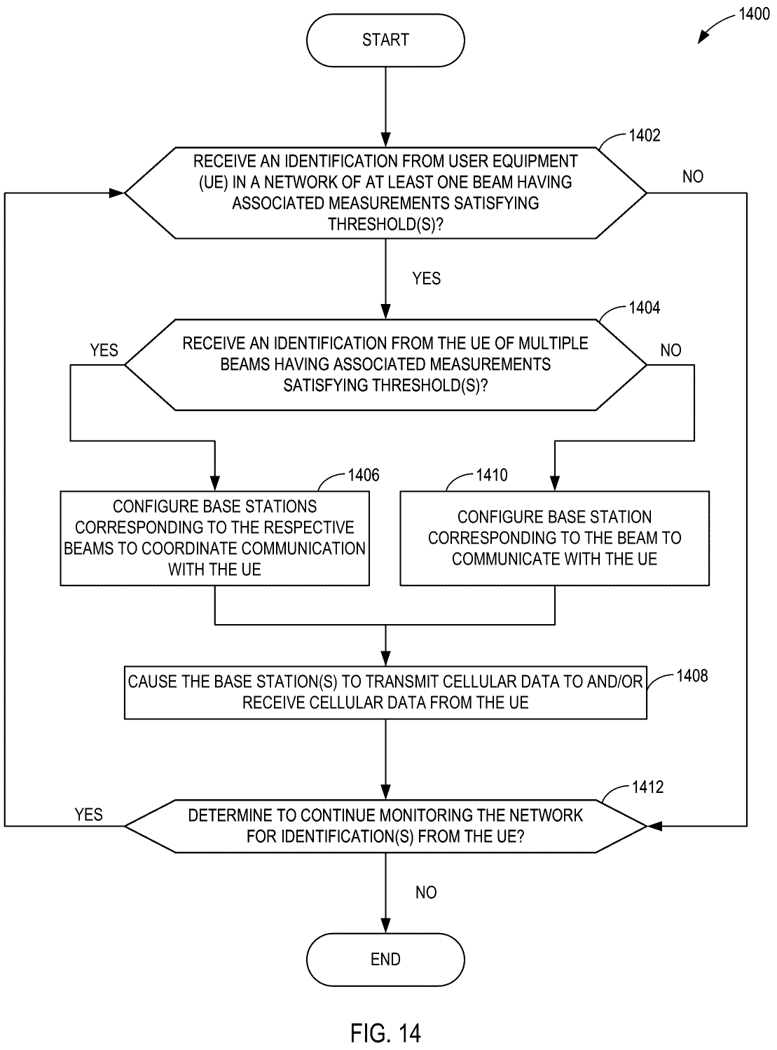

FIG. 14 is a flowchart 1400 that may be executed to implement the DU circuitry 900 of FIG. 9 to facilitate communication of a base station with a cellular device. The flowchart 1400 of FIG. 14 begins at block 1402, at which the DU circuitry 900 may determine whether it has received an identification from user equipment (UE) in a network of at least one beam having associated measurements satisfying threshold(s). If, at block 1402, the DU circuitry 900 determines that it has not received such an identification, control proceeds to block 1412. Otherwise, control proceeds to block 1404.

At block 1404, the DU circuitry 900 may determine whether it has received an identification from the UE of multiple beams having associated measurements satisfying threshold(s). If, at block 1404, the DU circuitry 900 determines that it has received an identification from the UE of multiple beams having associated measurements satisfying threshold(s), control proceeds to block 1406.

At block 1406, the DU circuitry 900 may configure base stations corresponding to the respective beams to coordinate communication with the UE. For example, the configuration circuitry 960 (FIG. 9) may configure base stations corresponding to respective ones of the multiple beams for communication with the UE that originated the identification.

At block 1408, the DU circuitry 900 may cause the base station(s) to transmit cellular data to and/or receive cellular data from the UE. For example, the configuration circuitry 960 may transmit commands, such as MAC layer commands or RRC control commands, to the base stations to communicate with the UE via the at least one beam.

If, at block 1404, the DU circuitry 900 does not determine that it has received an identification from the UE of multiple beams having associated measurements satisfying threshold(s), control proceeds to block 1410. At block 1410, the DU circuitry 900 may configure a base station corresponding to the beam to communicate with the UE. After block 1410, control proceeds to block 1408. After block 1408, control proceeds to block 1412.

At block 1412, the DU circuitry 900 may determine whether to continue monitoring the network for identification(s) from the UE. If, at block 1412, the DU circuitry 900 determines to continue monitoring the network for identification(s) from the UE, control returns to block 1402. Otherwise, the flowchart 1400 of FIG. 14 concludes.

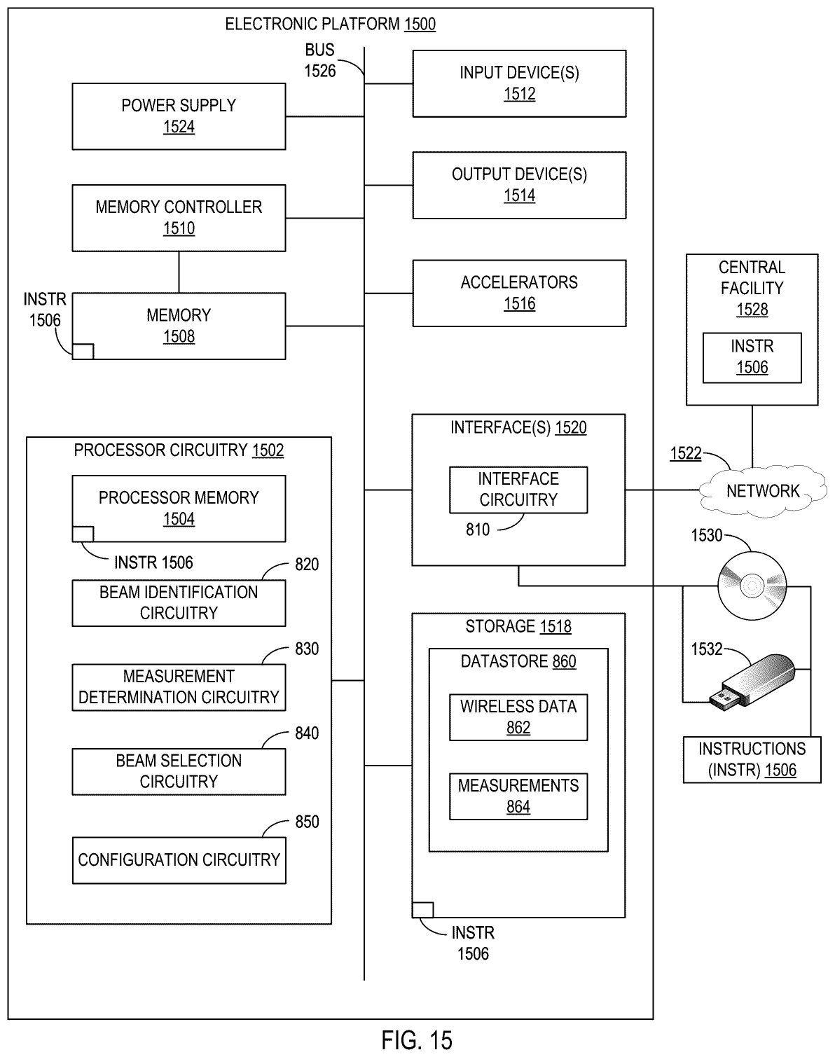

FIG. 15 is an example implementation of an electronic platform 1500 structured to execute the machine-readable instructions of FIGS. 10, 11, and/or 13 to implement a cellular device and/or a UE, such as the cellular device circuitry 800 of FIG. 8. It should be appreciated that FIG. 15 is intended neither to be a description of necessary components for an electronic and/or computing device to operate as a cellular device, UE, and/or cellular device circuitry, in accordance with the techniques described herein, nor a comprehensive depiction. The electronic platform 1500 of this example may be an electronic device, such as a cellular network device, a desktop computer, a laptop computer, a server (e.g., a computer server, a blade server, a rack-mounted server, etc.), a workstation, an IoT device, autonomous equipment, or any other type of computing and/or electronic device.

The electronic platform 1500 of the illustrated example includes processor circuitry 1502, which may be implemented by one or more programmable processors, one or more hardware-implemented state machines, one or more ASICs, etc., and/or any combination(s) thereof. For example, the one or more programmable processors may include one or more CPUs, one or more DSPs, one or more FPGAs, etc., and/or any combination(s) thereof. The processor circuitry 1502 includes processor memory 1504, which may be volatile memory, such as random-access memory (RAM) of any type. The processor circuitry 1502 of this example implements the beam identification circuitry 820, the measurement determination circuitry 830, the beam selection circuitry 840, and the configuration circuitry 850 of FIG. 8.

The processor circuitry 1502 may execute machine-readable instructions 1506 (identified by INSTRUCTIONS), which are stored in the processor memory 1504, to implement at least one of the cellular device circuitry 800 of FIG. 8. The machine-readable instructions 1506 may include data representative of computer-executable and/or machine-executable instructions implementing techniques that operate according to the techniques described herein. For example, the machine-readable instructions 1506 may include data (e.g., code, embedded software (e.g., firmware), software, etc.) representative of the flowcharts of FIGS. 10, 11, and/or 13, or portion(s) thereof.

The electronic platform 1500 includes memory 1508, which may include the instructions 1506. The memory 1508 of this example may be controlled by a memory controller 1510. For example, the memory controller 1510 may control reads, writes, and/or, more generally, access(es) to the memory 1508 by other component(s) of the electronic platform 1500. The memory 1508 of this example may be implemented by volatile memory, non-volatile memory, etc., and/or any combination(s) thereof. For example, the volatile memory may include static random-access memory (SRAM), dynamic random-access memory (DRAM), cache memory (e.g., Level 1 (L1) cache memory, Level 2 (L2) cache memory, Level 3 (L3) cache memory, etc.), etc., and/or any combination(s) thereof. In some examples, the non-volatile memory may include Flash memory, electrically erasable programmable read-only memory (EEPROM), magnetoresistive random-access memory (MRAM), ferroelectric random-access memory (FeRAM, F-RAM, or FRAM), etc., and/or any combination(s) thereof.

The electronic platform 1500 includes input device(s) 1512 to enable data and/or commands to be entered into the processor circuitry 1502. For example, the input device(s) 1512 may include an audio sensor, a camera (e.g., a still camera, a video camera, etc.), a keyboard, a microphone, a mouse, a touchscreen, a voice recognition system, etc., and/or any combination(s) thereof.

The electronic platform 1500 includes output device(s) 1514 to convey, display, and/or present information to a user (e.g., a human user, a machine user, etc.). For example, the output device(s) 1514 may include one or more display devices, speakers, etc. The one or more display devices may include an augmented reality (AR) and/or virtual reality (VR) display, a liquid crystal display (LCD), a light-emitting diode (LED) display, an organic light-emitting diode (OLED) display, a quantum dot (QLED) display, a thin-film transistor (TFT) LCD, a touchscreen, etc., and/or any combination(s) thereof. The output device(s) 1514 can be used, among other things, to generate, launch, and/or present a user interface. For example, the user interface may be generated and/or implemented by the output device(s) 1514 for visual presentation of output and speakers or other sound generating devices for audible presentation of output.

The electronic platform 1500 includes accelerators 1516, which are hardware devices to which the processor circuitry 1502 may offload compute tasks to accelerate their processing. For example, the accelerators 1516 may include artificial intelligence/machine-learning (AI/ML) processors, ASICs, FPGAs, graphics processing units (GPUs), neural network (NN) processors, systems-on-chip (SoCs), vision processing units (VPUs), etc., and/or any combination(s) thereof. In some examples, one or more of the beam identification circuitry 820, the measurement determination circuitry 830, the beam selection circuitry 840, and/or the configuration circuitry 850 may be implemented by one(s) of the accelerators 1516 instead of the processor circuitry 1502. In some examples, the beam identification circuitry 820, the measurement determination circuitry 830, the beam selection circuitry 840, and/or the configuration circuitry 850 may be executed concurrently (e.g., in parallel, substantially in parallel, etc.) by the processor circuitry 1502 and the accelerators 1516. For example, the processor circuitry 1502 and one(s) of the accelerators 1516 may execute in parallel function(s) corresponding to the beam identification circuitry 820.

The electronic platform 1500 includes storage 1518 to record and/or control access to data, such as the machine-readable instructions 1506. In this example, the storage 1518 may implement the datastore 860 of FIG. 8, which includes the wireless data 862 and the measurements 864 of FIG. 8. The storage 1518 may be implemented by one or more mass storage disks or devices, such as HDDs, SSDs, etc., and/or any combination(s) thereof.

The electronic platform 1500 includes interface(s) 1520 to effectuate exchange of data with external devices (e.g., computing and/or electronic devices of any kind) via a network 1522. In this example, the interface(s) 1520 may implement the interface circuitry 810 of FIG. 8. The interface(s) 1520 of the illustrated example may be implemented by an interface device, such as network interface circuitry (e.g., a NIC, a smart NIC, etc.), a gateway, a router, a switch, etc., and/or any combination(s) thereof. The interface(s) 1520 may implement any type of communication interface, such as BLUETOOTH®, a cellular telephone system (e.g., a 4G LTE interface, a 5G interface, a future generation 6G interface, etc.), an Ethernet interface, a near-field communication (NFC) interface, an optical disc interface (e.g., a Blu-ray disc drive, a CD drive, a DVD drive, etc.), an optical fiber interface, a satellite interface (e.g., a BLOS satellite interface, a LOS satellite interface, etc.), a Universal Serial Bus (USB) interface (e.g., USB Type-A, USB Type-B, USB TYPE-C™ or USB-C™, etc.), etc., and/or any combination(s) thereof.

The electronic platform 1500 includes a power supply 1524 to store energy and provide power to components of the electronic platform 1500. The power supply 1524 may be implemented by a power converter, such as an alternating current-to-direct-current (AC/DC) power converter, a direct current-to-direct current (DC/DC) power converter, etc., and/or any combination(s) thereof. For example, the power supply 1524 may be powered by an external power source, such as an alternating current (AC) power source (e.g., an electrical grid), a direct current (DC) power source (e.g., a battery, a battery backup system, etc.), etc., and the power supply 1524 may convert the AC input or the DC input into a suitable voltage for use by the electronic platform 1500. In some examples, the power supply 1524 may be a limited duration power source, such as a battery (e.g., a rechargeable battery such as a lithium-ion battery).

Component(s) of the electronic platform 1500 may be in communication with one(s) of each other via a bus 1526. In some embodiments, the bus 1526 of this example may implement the bus 870 of FIG. 8. For example, the bus 1526 may be any type of computing and/or electrical bus, such as an I2C bus, a PCI bus, a PCIe bus, a SPI bus, and/or the like.

The network 1522 may be implemented by any wired and/or wireless network(s) such as one or more cellular networks (e.g., 4G LTE cellular networks, 5G cellular networks, future generation 6G cellular networks, etc.), one or more data buses, one or more local area networks (LANs), one or more optical fiber networks, one or more private networks, one or more public networks, one or more wireless local area networks (WLANs), etc., and/or any combination(s) thereof. For example, the network 1522 may be the Internet, but any other type of private and/or public network is contemplated.

The network 1522 of the illustrated example facilitates communication between the interface(s) 1520 and a central facility 1528. The central facility 1528 in this example may be an entity associated with one or more servers, such as one or more physical hardware servers and/or virtualizations of the one or more physical hardware servers. For example, the central facility 1528 may be implemented by a public cloud provider, a private cloud provider, etc., and/or any combination(s) thereof. In this example, the central facility 1528 may compile, generate, update, etc., the machine-readable instructions 1506 and store the machine-readable instructions 1506 for access (e.g., download) via the network 1522. For example, the electronic platform 1500 may transmit a request, via the interface(s) 1520, to the central facility 1528 for the machine-readable instructions 1506 and receive the machine-readable instructions 1506 from the central facility 1528 via the network 1522 in response to the request.

Additionally or alternatively, the interface(s) 1520 may receive the machine-readable instructions 1506 via non-transitory machine-readable storage media, such as an optical disc 1530 (e.g., a Blu-ray disc, a CD, a DVD, etc.) or any other type of removable non-transitory machine-readable storage media such as a USB drive 1532. For example, the optical disc 1530 and/or the USB drive 1532 may store the machine-readable instructions 1506 thereon and provide the machine-readable instructions 1506 to the electronic platform 1500 via the interface(s) 1520.

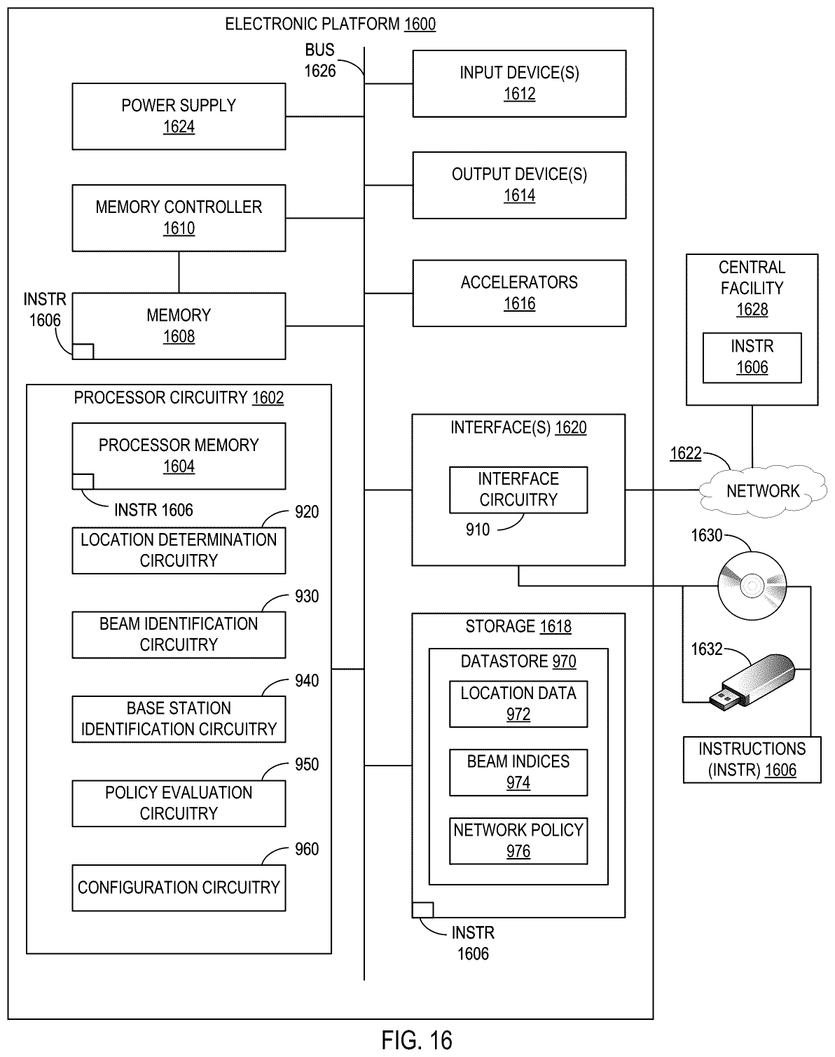

FIG. 16 is an example implementation of an electronic platform 1600 structured to execute the machine-readable instructions of FIGS. 11, 12, and/or 14 to implement a DU, such as the DU circuitry 900 of FIG. 9. It should be appreciated that FIG. 16 is intended neither to be a description of necessary components for an electronic and/or computing device to operate as a DU and/or DU circuitry, in accordance with the techniques described herein, nor a comprehensive depiction. The electronic platform 1600 of this example may be an electronic device, such as a cellular network device, a desktop computer, a laptop computer, a server (e.g., a computer server, a blade server, a rack-mounted server, etc.), a workstation, or any other type of computing and/or electronic device.

The electronic platform 1600 of the illustrated example includes processor circuitry 1602, which may be implemented by one or more programmable processors, one or more hardware-implemented state machines, one or more ASICs, etc., and/or any combination(s) thereof. For example, the one or more programmable processors may include one or more CPUs, one or more DSPs, one or more FPGAs, etc., and/or any combination(s) thereof. The processor circuitry 1602 includes processor memory 1604, which may be volatile memory, such as RAM of any type. The processor circuitry 1602 of this example implements the location determination circuitry 920, the beam identification circuitry 930, the base station identification circuitry 940, the policy evaluation circuitry 950, and/or the configuration circuitry 960 of FIG. 9.

The processor circuitry 1602 may execute machine-readable instructions 1606 (identified by INSTRUCTIONS), which are stored in the processor memory 1604, to implement at least one of the DU circuitry 900 of FIG. 9. The machine-readable instructions 1606 may include data representative of computer-executable and/or machine-executable instructions implementing techniques that operate according to the techniques described herein. For example, the machine-readable instructions 1606 may include data (e.g., code, embedded software (e.g., firmware), software, etc.) representative of the flowcharts of FIGS. 11, 12, and/or 14, or portion(s) thereof.

The electronic platform 1600 includes memory 1608, which may include the instructions 1606. The memory 1608 of this example may be controlled by a memory controller 1610. For example, the memory controller 1610 may control reads, writes, and/or, more generally, access(es) to the memory 1608 by other component(s) of the electronic platform 1600. The memory 1608 of this example may be implemented by volatile memory, non-volatile memory, etc., and/or any combination(s) thereof. For example, the volatile memory may include SRAM, DRAM, cache memory (e.g., L1 cache memory, L2 cache memory, L3 cache memory, etc.), etc., and/or any combination(s) thereof. In some examples, the non-volatile memory may include Flash memory, EEPROM, MRAM, FeRAM, etc., and/or any combination(s) thereof.

The electronic platform 1600 includes input device(s) 1612 to enable data and/or commands to be entered into the processor circuitry 1602. For example, the input device(s) 1612 may include an audio sensor, a camera (e.g., a still camera, a video camera, etc.), a keyboard, a microphone, a mouse, a touchscreen, a voice recognition system, etc., and/or any combination(s) thereof.

The electronic platform 1600 includes output device(s) 1614 to convey, display, and/or present information to a user (e.g., a human user, a machine user, etc.). For example, the output device(s) 1614 may include one or more display devices, speakers, etc. The one or more display devices may include an AR and/or VR display, an LCD, an LED display, an OLED display, a QLED display, a TFT LCD, a touchscreen, etc., and/or any combination(s) thereof. The output device(s) 1614 can be used, among other things, to generate, launch, and/or present a user interface. For example, the user interface may be generated and/or implemented by the output device(s) 1614 for visual presentation of output and speakers or other sound generating devices for audible presentation of output.

The electronic platform 1600 includes accelerators 1616, which are hardware devices to which the processor circuitry 1602 may offload compute tasks to accelerate their processing. For example, the accelerators 1616 may include AI/ML processors, ASICs, FPGAs, GPUs, NN processors, SoCs, VPUs, etc., and/or any combination(s) thereof. In some examples, one or more of the location determination circuitry 920, the beam identification circuitry 930, the base station identification circuitry 940, the policy evaluation circuitry 950, and/or the configuration circuitry 960 may be implemented by one(s) of the accelerators 1616 instead of the processor circuitry 1602. In some examples, the location determination circuitry 920, the beam identification circuitry 930, the base station identification circuitry 940, the policy evaluation circuitry 950, and/or the configuration circuitry 960 may be executed concurrently (e.g., in parallel, substantially in parallel, etc.) by the processor circuitry 1602 and the accelerators 1616. For example, the processor circuitry 1602 and one(s) of the accelerators 1616 may execute in parallel function(s) corresponding to the location determination circuitry 920.

The electronic platform 1600 includes storage 1618 to record and/or control access to data, such as the machine-readable instructions 1606. In this example, the storage 1618 may implement the datastore 970 of FIG. 9, which includes the location data 972, the beam indices 974, and the network policy 976 of FIG. 9. The storage 1618 may be implemented by one or more mass storage disks or devices, such as HDDs, SSDs, etc., and/or any combination(s) thereof.

The electronic platform 1600 includes interface(s) 1620 to effectuate exchange of data with external devices (e.g., computing and/or electronic devices of any kind) via a network 1622. In this example, the interface(s) 1620 may implement the interface circuitry 910 of FIG. 9. The interface(s) 1620 of the illustrated example may be implemented by an interface device, such as network interface circuitry (e.g., a NIC, a smart NIC, etc.), a gateway, a router, a switch, etc., and/or any combination(s) thereof. The interface(s) 1620 may implement any type of communication interface, such as BLUETOOTH®, a cellular telephone system (e.g., a 4G LTE interface, a 5G interface, a future generation 6G interface, etc.), an Ethernet interface, a near-field communication (NFC) interface, an optical disc interface (e.g., a Blu-ray disc drive, a CD drive, a DVD drive, etc.), an optical fiber interface, a satellite interface (e.g., a BLOS satellite interface, a LOS satellite interface, etc.), a USB interface (e.g., USB Type-A, USB Type-B, USB TYPE-C™ or USB-C™, etc.), etc., and/or any combination(s) thereof.

The electronic platform 1600 includes a power supply 1624 to store energy and provide power to components of the electronic platform 1600. The power supply 1624 may be implemented by a power converter, such as an AC/DC power converter, a DC/DC power converter, etc., and/or any combination(s) thereof. For example, the power supply 1624 may be powered by an external power source, such as an AC power source (e.g., an electrical grid), a DC power source (e.g., a battery, a battery backup system, etc.), etc., and the power supply 1624 may convert the AC input or the DC input into a suitable voltage for use by the electronic platform 1600. In some examples, the power supply 1624 may be a limited duration power source, such as a battery (e.g., a rechargeable battery such as a lithium-ion battery).

Component(s) of the electronic platform 1600 may be in communication with one(s) of each other via a bus 1626. In some embodiments, the bus 1626 of this example may implement the bus 980 of FIG. 9. For example, the bus 1626 may be any type of computing and/or electrical bus, such as an I2C bus, a PCI bus, a PCIe bus, a SPI bus, and/or the like.

The network 1622 may be implemented by any wired and/or wireless network(s) such as one or more cellular networks (e.g., 4G LTE cellular networks, 5G cellular networks, future generation 6G cellular networks, etc.), one or more data buses, one or more LANs, one or more optical fiber networks, one or more private networks, one or more public networks, one or more WLANs, etc., and/or any combination(s) thereof. For example, the network 1622 may be the Internet, but any other type of private and/or public network is contemplated.

The network 1622 of the illustrated example facilitates communication between the interface(s) 1620 and a central facility 1628. The central facility 1628 in this example may be an entity associated with one or more servers, such as one or more physical hardware servers and/or virtualizations of the one or more physical hardware servers. For example, the central facility 1628 may be implemented by a public cloud provider, a private cloud provider, etc., and/or any combination(s) thereof. In this example, the central facility 1628 may compile, generate, update, etc., the machine-readable instructions 1606 and store the machine-readable instructions 1606 for access (e.g., download) via the network 1622. For example, the electronic platform 1600 may transmit a request, via the interface(s) 1620, to the central facility 1628 for the machine-readable instructions 1606 and receive the machine-readable instructions 1606 from the central facility 1628 via the network 1622 in response to the request.

Additionally or alternatively, the interface(s) 1620 may receive the machine-readable instructions 1606 via non-transitory machine-readable storage media, such as an optical disc 1630 (e.g., a Blu-ray disc, a CD, a DVD, etc.) or any other type of removable non-transitory machine-readable storage media such as a USB drive 1632. For example, the optical disc 1630 and/or the USB drive 1632 may store the machine-readable instructions 1606 thereon and provide the machine-readable instructions 1606 to the electronic platform 1600 via the interface(s) 1620.

Techniques operating according to the principles described herein may be implemented in any suitable manner. The processing and decision blocks of the flowcharts above represent steps and acts that may be included in algorithms that carry out these various processes. Algorithms derived from these processes may be implemented as software integrated with and directing the operation of one or more single- or multi-purpose processors, may be implemented as functionally equivalent circuits such as a DSP circuit or an ASIC, or may be implemented in any other suitable manner. It should be appreciated that the flowcharts included herein do not depict the syntax or operation of any particular circuit or of any particular programming language or type of programming language. Rather, the flowcharts illustrate the functional information one skilled in the art may use to fabricate circuits or to implement computer software algorithms to perform the processing of a particular apparatus carrying out the types of techniques described herein. For example, the flowcharts, or portion(s) thereof, may be implemented by hardware alone (e.g., one or more analog or digital circuits, one or more hardware-implemented state machines, etc., and/or any combination(s) thereof) that is configured or structured to carry out the various processes of the flowcharts. In some examples, the flowcharts, or portion(s) thereof, may be implemented by machine-executable instructions (e.g., machine-readable instructions, computer-readable instructions, computer-executable instructions, etc.) that, when executed by one or more single- or multi-purpose processors, carry out the various processes of the flowcharts. It should also be appreciated that, unless otherwise indicated herein, the particular sequence of steps and/or acts described in each flowchart is merely illustrative of the algorithms that may be implemented and can be varied in implementations and embodiments of the principles described herein.

Accordingly, in some embodiments, the techniques described herein may be embodied in machine-executable instructions implemented as software, including as application software, system software, firmware, middleware, embedded code, or any other suitable type of computer code. Such machine-executable instructions may be generated, written, etc., using any of a number of suitable programming languages and/or programming or scripting tools, and also may be compiled as executable machine language code or intermediate code that is executed on a framework, virtual machine, or container.

When techniques described herein are embodied as machine-executable instructions, these machine-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc., that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement using the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (e.g., as a single unit or separate units), or some of these functional facilities may not be implemented.

Machine-executable instructions implementing the techniques described herein (when implemented as one or more functional facilities or in any other manner) may, in some embodiments, be encoded on one or more computer-readable media, machine-readable media, etc., to provide functionality to the media. Computer-readable media include magnetic media such as a hard disk drive, optical media such as a CD or a DVD, a persistent or non-persistent solid-state memory (e.g., Flash memory, Magnetic RAM, etc.), or any other suitable storage media. Such a computer-readable medium may be implemented in any suitable manner. As used herein, the terms “computer-readable media” (also called “computer-readable storage media”) and “machine-readable media” (also called “machine-readable storage media”) refer to tangible storage media. Tangible storage media are non-transitory and have at least one physical, structural component. In a “computer-readable medium” and “machine-readable medium” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium, a machine-readable medium, etc., may be altered during a recording process.

Further, some techniques described above comprise acts of storing information (e.g., data and/or instructions) in certain ways for use by these techniques. In some implementations of these techniques—such as implementations where the techniques are implemented as machine-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as machine-executable instructions, these instructions may be executed on one or more suitable computing device(s) and/or electronic device(s) operating in any suitable computer and/or electronic system, or one or more computing devices (or one or more processors of one or more computing devices) and/or one or more electronic devices (or one or more processors of one or more electronic devices) may be programmed to execute the machine-executable instructions. A computing device, electronic device, or processor (e.g., processor circuitry) may be programmed to execute instructions when the instructions are stored in a manner accessible to the computing device, electronic device, or processor, such as in a data store (e.g., an on-chip cache or instruction register, a computer-readable storage medium and/or a machine-readable storage medium accessible via a bus, a computer-readable storage medium and/or a machine-readable storage medium accessible via one or more networks and accessible by the device/processor, etc.). Functional facilities comprising these machine-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more FPGAs for carrying out the techniques described herein, or any other suitable system.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc., described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

Various aspects are described in this disclosure, which include, but are not limited to, the following aspects:

1. A method for base station management, the method comprising: determining a first measurement based on a first reference signal of a plurality of reference signals from a plurality of base stations and received at a cellular device, the first reference signal received at the cellular device from a first base station of the plurality of base stations using a beam associated with a beam index, the beam index corresponding to the first base station; determining whether the first measurement satisfies a threshold; selecting the beam for communication between the cellular device and the first base station after determining that the first measurement satisfies the threshold; and configuring the cellular device using the beam index to facilitate communication between the cellular device and the first base station.

2. The method of aspect 1, wherein the plurality of reference signals is representative of a plurality of synchronization signal blocks (SSBs), the plurality of SSBs including at least one of a primary synchronization signal (PSS) or a secondary synchronization signal (SSS).

3. The method of aspect 2, wherein a first one of the plurality of SSBs corresponds to the beam.

4. The method of aspect 1, wherein the plurality of reference signals is representative of at least one of a demodulation reference signal (DMRS) or a physical broadcast channel (PBCH).

5. The method of aspect 1, wherein the plurality of reference signals is representative of a plurality of channel state information reference signals (CSI-RSs).

6. The method of aspect 1, wherein the first measurement is representative of beam strength of the beam, and the method further comprising determining the beam strength of the first reference signal based on received signal power associated with receiving the first reference signal at the cellular device.

7. The method of aspect 1, wherein the beam is a first beam, the beam index is a first beam index, and the method further comprising: determining a second measurement based on a second reference signal of the plurality of reference signals, the second reference signal received at the cellular device from a second base station using a second beam associated with a second beam index, the second beam index corresponding to the second base station; after determining that the second measurement satisfies the threshold, selecting the second beam for communication between the cellular device and the second base station; and configuring the cellular device using the first beam index after determining that (i) a first signal power received by the cellular device from the first base station is greater than (ii) a second signal power received by the cellular device from the second base station.

8. The method of aspect 7, further comprising configuring the cellular device using the second beam index to cause communication between the cellular device and the second base station after determining that the signal power received from the second base station is stronger than that from the first base station.

9. The method of aspect 8, wherein a change in communication from (i) between the cellular device and the first base station to (ii) between the cellular device and the second base station does not comprise a handover from the first base station and the second base station.

10. The method of aspect 1, wherein the beam is a first beam, and the method further comprising: identifying a second beam associated with a second base station; and configuring the first base station and the second base station to transmit duplicate signals to the cellular device.

11. The method of aspect 10, wherein the first base station and the second base station are associated with the same supercell.

12. The method of aspect 10, further comprising establishing a supercell including the first base station and the second base station.

13. The method of aspect 10, further comprising: obtaining a network policy; and determining to configure the first base station and the second base station to transmit duplicate signals to the cellular device based on the network policy.

14. The method of aspect 10, further comprising: transmitting wireless data from the cellular device to the first base station to cause a distributed unit in communication with the first base station to generate first processed wireless data by processing the wireless data; and transmitting the wireless data from the cellular device to the second base station to cause the distributed unit in communication with the second base station to generate second processed wireless data by processing the wireless data.

15. The method of aspect 14, wherein the processing of the wireless data at the distributed unit comprises decoding the wireless data at, at least one of, the first base station, the second base station, or the distributed unit.

16. The method of aspect 1, wherein the beam is a first beam, the beam index is a first beam index, and the method further comprising: identifying a second beam associated with a second beam index, the second beam index associated with a second base station; and providing the second beam index to the second base station to cause a distributed unit to configure the first base station to transmit wireless data to the cellular device using one or more resource blocks and the second base station to not transmit the wireless data to the cellular device using the one or more resource blocks.

17. The method of aspect 1, wherein the plurality of base stations is to sequentially transmit the plurality of reference signals in a plurality of directions.

18. The method of aspect 17, wherein the plurality of directions includes a first direction associated with the beam index, and the method further comprising reporting the beam index from the cellular device to a distributed unit.

19. The method of aspect 18, wherein the reporting of the beam index causes the distributed unit to configure the first base station to communicate with the cellular device.

20. The method of aspect 18, wherein the distributed unit is configured to perform beam sweeping by configuring a plurality of base stations to sequentially transmit a plurality of reference signals.

21. The method of aspect 1, wherein the communication between the cellular device and the first base station is through the beam.

22. The method of aspect 1, wherein the beam is a first beam, and the method further comprising configuring the cellular device to periodically detect at least one of the first beam or one or more second beams.

23. A method for base station management, comprising: receiving a beam index from a cellular device indicating that a beam corresponding to the beam index is associated with a measurement satisfying a threshold; configuring a base station corresponding to the beam index to communicate with the cellular device; and transmitting data to the cellular device to cause configuration of the cellular device such that communication between the cellular device and the base station is through the beam.

24. The method of aspect 23, wherein the beam index is a first beam index, the beam is a first beam, the measurement is a first measurement, the base station is a first base station, and the method further comprising: after receiving the first beam index, receiving a second beam index from the cellular device indicating that a second beam corresponding to the second beam index is associated with a second measurement satisfying a threshold; configuring a second base station corresponding to the second beam index to communicate with the cellular device; configuring the cellular device to communicate using the second beam; and causing communication between the cellular device and the second base station using the second beam.

25. The method of aspect 24, wherein the cellular device is to communicate with the first base station using the first beam and the second base station using the second beam.

26. The method of aspect 24, wherein the first base station and the second base station are configured to transmit the same wireless data to the cellular device.

27. The method of aspect 24, further comprising: configuring the first base station to transmit first wireless data using one or more first resource blocks associated with the cellular device; and configuring the second base station to transmit second wireless data using one or more second resource blocks associated with the cellular device.

28. The method of aspect 27, wherein at least one of the one or more first resource blocks is the same as at least one of the one or more second resource blocks.

29. The method of aspect 27, wherein the one or more first resource blocks are different from the one or more second resource blocks.

30. The method of aspect 23, further comprising configuring the base station to operate in accordance with a Split Option 6 Open Radio Access Network Alliance architecture.

31. An apparatus comprising at least one memory storing instructions, and at least one processor configured to execute the instructions to perform the method of any one of aspects 1-30.

32. At least one non-transitory computer-readable storage medium comprising instructions that, when executed, cause at least one processor to perform the method of any one of aspects 1-30.

33. A system comprising at least one memory storing instructions, and at least one processor configured to execute the instructions to perform the method of any one of aspects 1-30.

What is claimed is:

1. A method for base station management, the method comprising:
determining a first measurement based on a first reference signal of a plurality of reference signals from a plurality of base stations and received at a cellular device, the first reference signal received at the cellular device from a first base station of the plurality of base stations using a beam associated with a beam index, the beam index corresponding to the first base station;
determining whether the first measurement satisfies a threshold;
selecting the beam for communication between the cellular device and the first base station after determining that the first measurement satisfies the threshold; and
configuring the cellular device using the beam index to facilitate communication between the cellular device and the first base station.

2. The method of claim 1, wherein the plurality of reference signals is representative of a plurality of synchronization signal blocks (SSBs), the plurality of SSBs including at least one of a primary synchronization signal (PSS) or a secondary synchronization signal (SSS).

3. The method of claim 2, wherein a first one of the plurality of SSBs corresponds to the beam.

4. The method of claim 1, wherein the plurality of reference signals is representative of at least one of a demodulation reference signal (DMRS) or a physical broadcast channel (PBCH).

5. The method of claim 1, wherein the plurality of reference signals is representative of a plurality of channel state information reference signals (CSI-RSs).

6. The method of claim 1, wherein the first measurement is representative of beam strength of the beam, and the method further comprising determining the beam strength of the first reference signal based on received signal power associated with receiving the first reference signal at the cellular device.

7. The method of claim 1, wherein the beam is a first beam, the beam index is a first beam index, and the method further comprising:
determining a second measurement based on a second reference signal of the plurality of reference signals, the second reference signal received at the cellular device from a second base station using a second beam associated with a second beam index, the second beam index corresponding to the second base station;
after determining that the second measurement satisfies the threshold, selecting the second beam for communication between the cellular device and the second base station; and
configuring the cellular device using the first beam index after determining that (i) a first signal power received by the cellular device from the first base station is greater than (ii) a second signal power received by the cellular device from the second base station.

8. The method of claim 7, further comprising configuring the cellular device using the second beam index to cause communication between the cellular device and the second base station after determining that the signal power received from the second base station is stronger than that from the first base station.

9. The method of claim 8, wherein a change in communication from (i) between the cellular device and the first base station to (ii) between the cellular device and the second base station does not comprise a handover from the first base station and the second base station.

10. The method of claim 1, wherein the beam is a first beam, and the method further comprising:
identifying a second beam associated with a second base station; and
configuring the first base station and the second base station to transmit duplicate signals to the cellular device.

11. The method of claim 10, wherein the first base station and the second base station are associated with the same supercell.

12. The method of claim 10, further comprising establishing a supercell including the first base station and the second base station.

13. The method of claim 10, further comprising:
obtaining a network policy; and
determining to configure the first base station and the second base station to transmit duplicate signals to the cellular device based on the network policy.

14. The method of claim 10, further comprising:
transmitting wireless data from the cellular device to the first base station to cause a distributed unit in communication with the first base station to generate first processed wireless data by processing the wireless data; and
transmitting the wireless data from the cellular device to the second base station to cause the distributed unit in communication with the second base station to generate second processed wireless data by processing the wireless data.

15. The method of claim 14, wherein the processing of the wireless data at the distributed unit comprises decoding the wireless data at, at least one of, the first base station, the second base station, or the distributed unit.

16. The method of claim 1, wherein the beam is a first beam, the beam index is a first beam index, and the method further comprising:
identifying a second beam associated with a second beam index, the second beam index associated with a second base station; and
providing the second beam index to the second base station to cause a distributed unit to configure the first base station to transmit wireless data to the cellular device using one or more resource blocks and the second base station to not transmit the wireless data to the cellular device using the one or more resource blocks.

17. The method of claim 1, wherein the plurality of base stations is to sequentially transmit the plurality of reference signals in a plurality of directions.

18. The method of claim 17, wherein the plurality of directions includes a first direction associated with the beam index, and the method further comprising reporting the beam index from the cellular device to a distributed unit.

19. The method of claim 18, wherein the reporting of the beam index causes the distributed unit to configure the first base station to communicate with the cellular device.

20. The method of claim 18, wherein the distributed unit is configured to perform beam sweeping by configuring a plurality of base stations to sequentially transmit a plurality of reference signals.

21. The method of claim 1, wherein the communication between the cellular device and the first base station is through the beam.

22. The method of claim 1, wherein the beam is a first beam, and the method further comprising configuring the cellular device to periodically detect at least one of the first beam or one or more second beams.

23. A method for base station management, comprising:
receiving a beam index from a cellular device indicating that a beam corresponding to the beam index is associated with a measurement satisfying a threshold;
configuring a base station corresponding to the beam index to communicate with the cellular device; and
transmitting data to the cellular device to cause configuration of the cellular device such that communication between the cellular device and the base station is through the beam.

24. The method of claim 23, wherein the beam index is a first beam index, the beam is a first beam, the measurement is a first measurement, the base station is a first base station, and the method further comprising:
after receiving the first beam index, receiving a second beam index from the cellular device indicating that a second beam corresponding to the second beam index is associated with a second measurement satisfying a threshold;
configuring a second base station corresponding to the second beam index to communicate with the cellular device;
configuring the cellular device to communicate using the second beam; and
causing communication between the cellular device and the second base station using the second beam.

25. The method of claim 24, wherein the cellular device is to communicate with the first base station using the first beam and the second base station using the second beam.

26. The method of claim 24, wherein the first base station and the second base station are configured to transmit the same wireless data to the cellular device.

27. The method of claim 24, further comprising:
configuring the first base station to transmit first wireless data using one or more first resource blocks associated with the cellular device; and
configuring the second base station to transmit second wireless data using one or more second resource blocks associated with the cellular device.

28. The method of claim 27, wherein at least one of the one or more first resource blocks is the same as at least one of the one or more second resource blocks.

29. The method of claim 27, wherein the one or more first resource blocks are different from the one or more second resource blocks.

30. The method of claim 23, further comprising configuring the base station to operate in accordance with a Split Option 6 Open Radio Access Network Alliance architecture.

31. An apparatus comprising at least one memory storing instructions, and at least one processor configured to execute the instructions to perform the method of claim 1.

32. At least one non-transitory computer-readable storage medium comprising instructions that, when executed, cause at least one processor to perform the method of claim 1.

33. A system comprising at least one memory storing instructions, and at least one processor configured to execute the instructions to perform the method of claim 1.
